(19) United States
(12) Patent Application Publication
(10) Pub. No.: US 2015/0043492 A1
(43) Pub. Date: Feb. 12, 2015

(54) METHOD FOR PROVIDING DUAL CONNECTIVITY IN WIRELESS COMMUNICATION SYSTEM

(71) Applicant: Electronics and Telecommunications Research Institute, Daejeon (KR)

(72) Inventors: Seung-Kwon Baek, Daejeon (KR); Kyoung Seok Lee, Daejeon (KR); JungSook Bae, Daejeon (KR)

(21) Appl. No.: 14/457,696

(22) Filed: Aug. 12, 2014

(30) Foreign Application Priority Data
Aug. 12, 2013 (KR) 10-2013-0095249
Nov. 26, 2013 (KR) 10-2013-0144927
Jan. 29, 2014 (KR) 10-2014-0011064
Aug. 12, 2014 (KR) 10-2014-0104524

(51) Int. Cl. H04W 76/02; H04W 56/00; H04W 74/08; H04W 72/04

(52) U.S. Cl. CPC H04W 76/025; H04W 72/04; H04W 56/0005; H04W 74/0833
USPC 370/329

(57) ABSTRACT

Disclosed herein are a dual connectivity method including determining another base station to be dually connected with UE, setting up another base station, and reconfiguring the RRC connection of the UE with another base station, a method of changing a base station in a dual connectivity state, a method of hanging radio resources in a dual connectivity state, and a method of releasing dual connectivity.

### CROSS-REFERENCE TO RELATED APPLICATION

This application claims priority to and the benefit of Korean Patent Application Nos. 10-2013-0095249, 10-2013-0144927, 10-2014-0011064, and 10-2014-0104524 filed in the Korean Intellectual Property Office on Aug. 12, 2013, Nov. 26, 2013, Jan. 29, 2014, and Aug. 12, 2014, the entire contents of which are incorporated herein by reference.

### BACKGROUND OF THE INVENTION

(a) Field of the Invention

The present invention relates to a method of providing dual connectivity in a wireless communication system.

(b) Description of the Related Art

In 3GPP RAN2, three types of deployment scenarios for Small Cell Enhancement (SCE) are determined, and technical issues are being discussed for each scenario.

Scenario 1 is a case where a macrocell and a small cell connected by a non-ideal backhaul use an intra-carrier frequency. Scenario 2 is a case where a macrocell and a small cell connected by a non-ideal backhaul use inter-carrier frequencies. Scenario 3 is a case where a plurality of small cells using at least one carrier frequency are connected by a non-ideal backhaul, and the mobility of a terminal is low or middle.

Table 1 illustrates the technical requirements of each deployment scenario for SCE according to the results of the R2-82 conference in May of 2013.

TABLE 1

| | Scenario | | |
|---|---|---|---|
| Technical issues | Scenario 1 | Scenario 2 | Scenario 3 |
| Mobility robustness | X | X | |
| UL (uplink)/DL (downlink) | | | |
| power imbalance | | | |
| Increased signaling load | X | X | X |
| due to frequent handover | | | |
| Difficult to improve system | | X | |
| capacity (per-user | | | |
| throughput) by utilizing | | | |
| radio resource in more than | | | |
| one eNB | | | |
| Network planning and | | | |
| configuration effort | | | |
| Small cell discovery | X | X | X |
| | (HetNet WI) | (HetNet WI) | (HetNet WI) |

In order to satisfy such system requirements, there is a need to invent a method which enables the base station of a macrocell and the base station of a small cell to simultaneously communicate with a single terminal.

### SUMMARY OF THE INVENTION

The present invention has been made in an effort to provide a method for providing dual connectivity in a wireless communication system having an advantage of providing dual connectivity between two base stations connected by a non-ideal backhaul and a single terminal.

An exemplary embodiment of the present invention provides a method for dually connecting, by a base station, User Equipment (UE) with other base station. According to an embodiment of the present invention, the dually connecting method may include: determining a first base station of the at least one other base station; setting up the first base station; reconfiguring Radio Bearer (RB) connection of the UE with the first base station; and performing communication based on dual connectivity with the UE and the first base station.

In the dually connecting method, determining the first base station may include setting up the first base station as a secondary eNB (SeNB) for the UE.

In the dually connecting method, determining the first base station may include determining the first base station by taking a load of the base station into consideration.

In the dually connecting method, setting up the first base station may include: transferring a Secondary eNB (SeNB) setup message to the first base station; and receiving a response to the SeNB setup message from the first base station.

In the dually connecting method, the SeNB setup message may include at least one of information about a Cell-Radio Network Temporary Identifier (C-RNTI) of the UE, information about attributes of a bearer to be configured, and information about UE radio access capabilities.

In the dually connecting method, the response to the SeNB setup message may include a result code generated after an admission control procedure regarding whether a bearer has been configured is performed.

In the dually connecting method, reconfiguring the RRC connection may include: instructing the UE to access the first base station; and receiving a completion message for the access instruction from the UE.

In the dually connecting method may further include sending an SeNB setup complete message to the first base station after reconfiguring the RRC connection.

In the dually connecting method, reconfiguring the RRC connection may include performing reconfiguration the RB connection using an RRC connection reconfiguration message.

In the dually connecting method may further include updating RRC context of the first base station after reconfiguring the RRC connection.

In the dually connecting method may further include receiving a measurement result report on the at least one base station from the UE before determining a first base station.

In the dually connecting method, the measurement result report may include information about addable small cell to the UE.

Another embodiment of the present invention provides a method of changing secondary eNB (SeNB) in a wireless communication system in which User Equipment (UE) is dually connected with master eNB (MeNB) and the SeNB. According to the current embodiment of the present invention, the changing method may include: determining to change the SeNB from a source base station to a target base station and setting up the target base station; reconfiguring Radio Bearer (RB) connection of the UE with the target base station; and performing communication based on dual connectivity with the UE and the target base station.

In the changing method may further include buffering downlink data of a radio bearer of the UE after setting up the new base station.

In the changing method may further include releasing radio resources configured in the source base station after reconfiguring the RRC connection.

In the changing method may further include sending an SeNB setup complete message to the target base station after reconfiguring the RRC connection.

In the changing method may further include updating RRC context of the source base station after reconfiguring the RRC connection.

In the changing method, setting up the new base station may include: transferring a Secondary eNB (SeNB) setup message to the target base station to be connected to the UE; and receiving a response to the SeNB setup from the target base station.

In the changing method, reconfiguring the RRC connection may include: performing reconfiguration the RB connection using an RRC connection reconfiguration message for the target base station; and receiving an RRC connection reconfiguration complete message for the target base station from the UE.

Another embodiment of the present invention provides a method of changing radio resources allocated to secondary eNB (SeNB) in a wireless communication system in which User Equipment (UE) is dually connected with master eNB (MeNB) and the SeNB. According to the current embodiment of the present invention, the radio resource changing method may include: reconfiguring the radio resources allocated to the SeNB; reconfiguring Radio Bearer (RB) connection of the UE with the SeNB; and sending an SeNB reconfiguration complete message to the SeNB.

In the radio resource changing method may further include updating RRC context of the SeNB after reconfiguring the RB connection.

In the radio resource changing method, reconfiguring the radio resources may include: sending an SeNB reconfiguration message that orders the change of the radio resources to the SeNB; and receiving an SeNB reconfiguration response message, providing notification of the change of the radio resources allocated to the SeNB, from the SeNB.

In the radio resource changing method, wherein the SeNB reconfiguration message may include a parameter used to reconfigure a radio bearer and radio bearer identifier.

In the radio resource changing method, wherein reconfiguring the RRC connection may include: performing reconfiguration the RB connection using an RRC connection reconfiguration message for the first base station; and receiving an RRC connection reconfiguration complete message for the SeNB from the UE.

Another embodiment of the present invention provides a method of changing radio resources allocated secondary eNB (SeNB) in a wireless communication system in which User Equipment (UE) is dually connected with master eNB (MeNB) and the SeNB. According to the current embodiment of the present invention, the radio resource changing method may include: receiving an SeNB reconfiguration command that orders a change of radio resources allocated to the SeNB from the SeNB; reconfiguring Radio Bearer (RB) connection of the UE with the SeNB; and sending an SeNB reconfiguration complete message to the first base station.

In the radio resource changing method may further include: receiving a message that requests information about a state of radio resources configured in the UE from the SeNB before receiving the SeNB reconfiguration command; and sending a response message comprising the information about the state of the configured radio resources to the SeNB.

In the radio resource changing method may further include determining whether or not to change the radio resources allocated to the SeNB based on information about radio resources configured in the UE after receiving the SeNB reconfiguration command.

In the radio resource changing method may further include sending information about radio resources configured in the UE to the SeNB periodically or when the radio resources configured in the UE are changed.

In the radio resource changing method, reconfiguring the RB connection may include: performing reconfiguration the RB connection using an RRC connection reconfiguration message for the SeNB; and receiving an RRC connection reconfiguration complete message for the SeNB from the UE.

Another embodiment of the present invention provides a method of releasing connection of secondary eNB (SeNB) with User Equipment (UE) in a wireless communication system in which the UE dually connected with master eNB (MeNB) and the SeNB. According to the current embodiment of the present invention, the releasing method may include: determining to release connection for the SeNB; releasing radio resources allocated to the SeNB; and releasing Radio Bearer (RB) connection of the UE with the SeNB.

In the releasing method of claim 30 may further include receiving a measurement result report comprising information about radio connection of the UE or information about a radio channel of the UE from the UE before determining to release the connection with the SeNB, wherein determining to release the connection with the SeNB comprises determining to release the connection with the SeNB based on the measurement result report.

In the releasing method may further include receiving a measurement result report comprising information about radio connection of the UE or information about a radio channel of the UE from the UE before determining to release the connection with the SeNB, wherein releasing the radio resources may include: sending an SeNB release message that requests to release the radio resources based on the measurement result report to the SeNB; and receiving an SeNB release response message providing notification of the release of the radio resources from the SeNB.

In the releasing method, releasing the RB connection may include: sending an RRC connection reconfiguration message providing instruction of the release of the RB connection for the SeNB to the UE; and receiving an RRC reconfiguration complete message providing notification of the release of the RB connection with the SeNB from the UE.

Another embodiment of the present invention provides a method of releasing connection of secondary eNB (SeNB) with User Equipment (UE) in a wireless communication system in which the UE dually connected with master eNB (MeNB) and the SeNB. According to the current embodiment of the present invention, the method may include: receiving an SeNB release command from SeNB; releasing Radio Bearer (RB) connection of the UE with the SeNB; and updating RRC context of the SeNB.

In the releasing method of claim 34, releasing the RRC connection may include: sending an RRC connection reconfiguration message providing instruction of the release of the RB connection for the SeNB to the UE; and receiving an RRC reconfiguration complete message providing notification of the release of the RB connection with the SeNB from the UE.

Another embodiment of the present invention provides a method of releasing connection of secondary eNB (SeNB) with User Equipment (UE) in a wireless communication system in which the UE dually connected with master eNB (MeNB) and the SeNB. According to the current embodiment of the present invention, the releasing method may include: determining whether or not to release connection with the SeNB; updating Radio Resource Connection (RRC) context of the SeNB; releasing Radio Bearer (RB) connection of the UE with the SeNB; and releasing radio resources allocated to the SeNB.

In the releasing method, releasing the RB connection may include: sending an RRC connection reconfiguration message providing instruction of the release of the RB connection for the SeNB to the UE; and receiving an RRC reconfiguration complete message providing notification of the release of the RB connection with the SeNB from the UE.

In the releasing method may further include receiving a measurement result report comprising information about radio connection of the UE or information about a radio channel of the UE from the UE before determining whether or not to release the connection, wherein releasing the radio resources may include: sending an SeNB release message that requests to release the radio resources based on the measurement result report to the SeNB; and receiving an SeNB release response message providing notification of the release of the radio resources from the SeNB.

Another embodiment of the present invention provides a method for dually connecting, by a User Equipment (UE) connected to a base station, a first base station that is different from the base station. According to the current embodiment of the present invention, the dually connecting method may include: reconfiguring Radio Bearer (RB) connection with the first base station determined as a secondary eNB (SeNB) by the base station; and performing communication based on dual connectivity with the base station and the first base station.

In the dually connecting method, reconfiguring the RB connection may include: receiving reconfiguration command instructing the RB connection with the first base station from the base station; and performing uplink synchronization with the first base station.

In the dually connecting method, reconfiguring the RB connection may further include setting up the RB on the basis of the reconfiguration command after the performing the uplink synchronization.

In the dually connecting method, reconfiguration command may include information related random access for the first base station, wherein the performing the uplink synchronization may include performing non-contention based random access for the first base station.

In the dually connecting method, performing the uplink synchronization may include performing contention based random access for the first base station.

In the dually connecting method, reconfiguring the RB further may include transmitting an RRC Connection Reconfiguration complete message to the first base station.

In the dually connecting method may further include receiving instruction of measurement for finding the first base station and periodically performing the measurement for finding the first base station before reconfiguring the RB.

In the dually connecting method may further include reporting a result of the measurement when the UE finding the first base station matched a configuration condition, wherein the instruction of measurement comprising the configuration condition of the first base station.

Another embodiment of the present invention provides a method of changing, by User Equipment (UE) dually connected with master eNB (MeNB) and secondary eNB (SeNB), the SeNB in a wireless communication system. According to the current embodiment of the present invention, the changing method may include: releasing Radio Bearer (RB) connection with first base station connected as former SeNB and reconfiguring the RB connection with second base station determined as latter SeNB; and performing communication based on dual connectivity with the MeNB and the second base station.

In the changing method, reconfiguring the RB connection may include receiving an Radio Resource Control (RRC) connection reconfiguration message from the MeNB.

In the changing method, the RRC Connection reconfiguration message may include information related to the second base station and list of secondary cell included in coverage of the second base station.

In the changing method, reconfiguring the RB connection may include: buffering uplink data set for transmitting to the first base station; and performing uplink synchronization with the second base station, wherein the performing communication may include transferring the buffered data to the second base station.

### BRIEF DESCRIPTION OF THE DRAWINGS

FIG. 1 is a diagram illustrating a wireless communication system for providing dual connectivity in accordance with an exemplary embodiment of the present invention;

FIG. 2 is a diagram illustrating control plane functions (RRC and RRM) performed by an MeNB and an SeNB in an Alt.Arch.1 for providing dual connectivity in accordance with an exemplary embodiment of the present invention;

FIG. 3 is a diagram illustrating a protocol stack of user plane downlink in the wireless communication system for providing dual connectivity in accordance with an exemplary embodiment of the present invention;

FIG. 4 is a diagram illustrating a protocol stack of user plane uplink in the wireless communication system for providing dual connectivity in accordance with an exemplary embodiment of the present invention;

FIG. 5 is a diagram illustrating a case where a BM operates as an OM in accordance with an exemplary embodiment of the present invention;

FIG. 6 is a diagram illustrating an OM PDU and a TM PDU according to the operation of a BM in accordance with an exemplary embodiment of the present invention;

FIG. 7 is a diagram illustrating the interoperation structure of a BM in accordance with an exemplary embodiment of the present invention;

FIG. 8 is a diagram illustrating a channel mapping configuration for the dual connectivity of the SeNB of the Alt.Arch.1 in accordance with an exemplary embodiment of the present invention;

FIG. 9 is a diagram illustrating the buffer management structure of UE in accordance with an exemplary embodiment of the present invention;

FIG. 10A and FIG. 10B are a flowchart illustrating the SeNB addition procedure of the Alt.Arch.1 in accordance with an exemplary embodiment of the present invention;

FIG. 11 is a flowchart illustrating an SeNB addition method in the Alt.Arch.1 in accordance with another exemplary embodiment of the present invention;

FIGS. 12A, 12B and 13 are flowcharts illustrating a method of changing an SeNB in accordance with an exemplary embodiment of the present invention;

FIG. 14 is a flowchart illustrating a method of reconfiguring an SeNB in the Alt.Arch.1 in accordance with an exemplary embodiment of the present invention;

FIG. 15 is a flowchart illustrating a method of releasing an SeNB in the Alt.Arch.1 in accordance with an exemplary embodiment of the present invention;

FIG. 16 is a flowchart illustrating a method of reporting an SeNB buffer state in the Alt.Arch.1 in accordance with an exemplary embodiment of the present invention;

FIG. 17 is a diagram illustrating the connection state of an MeNB, an SeNB, and UE in the Alt.Arch.1 in accordance with an exemplary embodiment of the present invention;

FIG. 18 is a diagram illustrating the interoperation structure of a control plane in accordance with an exemplary embodiment of the present invention;

FIG. 19 is a diagram illustrating the interoperation structure of a user plane in accordance with an exemplary embodiment of the present invention;

FIG. 20 is a diagram illustrating a wireless communication system for providing dual connectivity in accordance with another exemplary embodiment of the present invention;

FIG. 21 is a diagram illustrating the functions and structures of RRC and RRM in the control plane of an Alt.Arch.2 for providing dual connectivity;

FIG. 22 is a diagram illustrating a protocol stack of a user plane downlink in the wireless communication system for providing dual connectivity in accordance with another exemplary embodiment of the present invention;

FIG. 23 is a diagram illustrating a protocol stack of a user plane uplink in the wireless communication system for providing dual connectivity in accordance with another exemplary embodiment of the present invention;

FIG. 24 is a diagram illustrating the uplink/downlink channel mapping configuration of an SeNB in accordance with another exemplary embodiment of the present invention;

FIG. 25 is a diagram illustrating the buffer management structure of UE in accordance with another exemplary embodiment of the present invention;

FIG. 26 is a flowchart illustrating an SeNB addition procedure in the Alt.Arch.2 in accordance with another exemplary embodiment of the present invention;

FIG. 27 is a flowchart illustrating a method of changing an SeNB in accordance with another exemplary embodiment of the present invention;

FIG. 28 is a flowchart illustrating a method of reconfiguring an SeNB in accordance with another exemplary embodiment of the present invention;

FIG. 29 is a flowchart illustrating a method of sharing radio resource allocation information in the Alt.Arch.2 in accordance with another exemplary embodiment of the present invention;

FIG. 30 is a flowchart illustrating a method of releasing an SeNB in the Alt.Arch.2 in accordance with another exemplary embodiment of the present invention; and

FIG. 31 is a diagram illustrating the connection state of an MeNB, an SeNB, and UE in the Alt.Arch.2 in accordance with another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, a Mobile Station (MS) may denote a terminal, a Mobile Terminal (MT), an Advanced Mobile Station (AMS), a High Reliability Mobile Station (HR-MS), a Subscriber Station (SS), a Portable Subscriber Station (PSS), an Access Terminal (AT), or User Equipment (UE), and may include all or some of the functions of the MT, MS, AMS, HR-MS, SS, PSS, AT, and UE.

Furthermore, a Base Station (BS) may denote an Advanced Base Station (ABS), a High Reliability Base Station (HR-BS), a node B, an evolved Node B (eNodeB), an Access Point (AP), a Radio Access Station (RAS), a Base Transceiver Station (BTS), a Mobile Multihop Relay (MMR)-BS, a Relay Station (RS) functioning as a base station, a Relay Node (RN) functioning as a base station, an Advanced Relay Station (ARS) functioning as a base station, a High Reliability Relay Station (HR-RS) functioning as a base station, a small BS [e.g., a femto BS, a Home NodeB (HNB), a home eNodeB (HeNB), a pico BS, a metro BS, and a micro BS], a master eNB (MeNB), or a secondary eNB (SeNB), and may include all or some of the functions of the ABS, HR-BS, eNodeB, AP, RAS, BTS, MMR-BS, RS, RN, ARS, HR-RS, and small BS.

Furthermore, unless explicitly described to the contrary, the word “comprise” and variations such as “comprises” or “comprising”, will be understood to imply the inclusion of stated elements but not the exclusion of any other elements. Furthermore, terms, such as “ . . . part”, “ . . . unit”, “ . . . or (or er)”, “module”, and “block” described in the specification, mean units configured to process at least one function or operation, which may be implemented using software, hardware such as a microprocessor, or a combination of software and hardware.

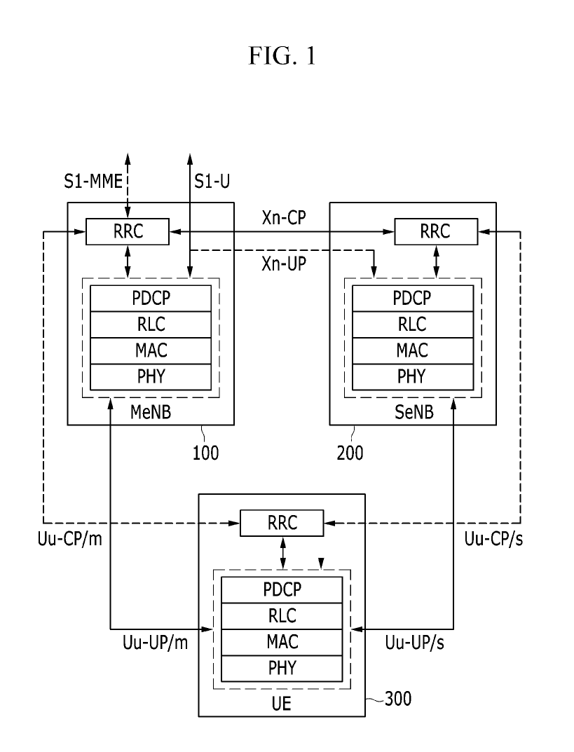

FIG. 1 is a diagram illustrating a wireless communication system for providing dual connectivity in accordance with an exemplary embodiment of the present invention.

FIG. 1 illustrates an Alternative Architecture (Alt.Arch.) 1 of a wireless communication system for providing dual connectivity.

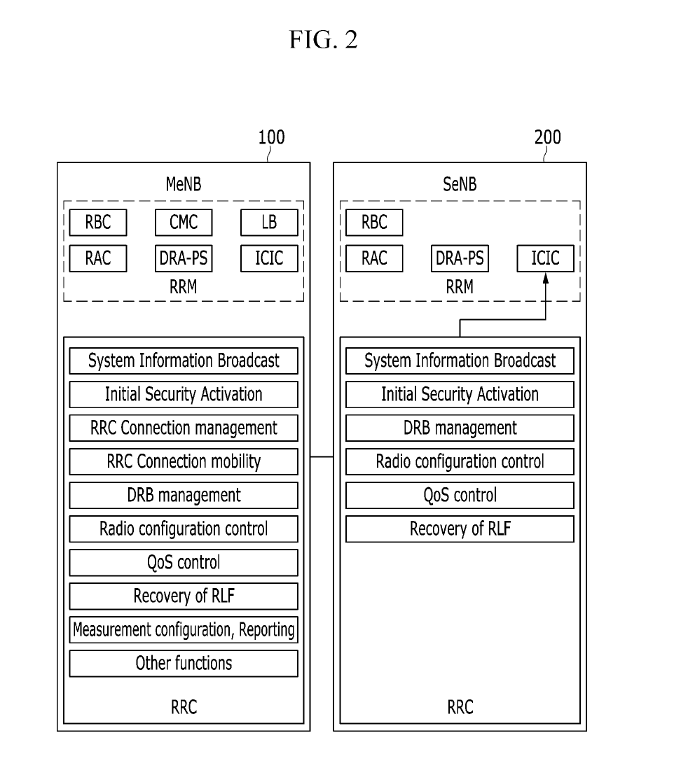

Referring to FIG. 1, the MeNB 100 of the Alt.Arch.1 is connected to a Mobility Management Entity (MME) and a serving gateway (S-GW) through a control plane interface (S1-MME) and a user plane interface (S1-U). In FIG. 2, the MeNB 100, an SeNB 200, and the UE 300 include the same protocol stack. The protocol stack included in each of the MeNB 100, the SeNB 200, and the UE 300 includes a Radio Resource Control (RRC) protocol, a Packet Data Collection Protocol (PDCP), a Radio Link Control (RLC) protocol, a Media Access Control (MAC) protocol, and a physical layer (PHY) protocol.

In FIG. 1, the Radio Resource Control (RRC) of the MeNB 100 and the RRC of the SeNB 200 perform a control plane protocol function for dual connectivity. In the present invention, each of the MeNB 100 and the SeNB 200 has a 2-layer protocol as a user plane protocol. In the present invention, each of the MeNB 100 and the SeNB 200 may provide a Carrier Aggregation (CA) function using a plurality of Component Carriers (CCs). Accordingly, each eNB manages a primary cell and at least one secondary cell. In this case, a group of cells managed by the MeNB 100 is called a Master Cell Group (MCG), and a group of cells managed by the SeNB 200 is called a Secondary Cell Group (SCG).

The functions and structures of the RRC and Radio Resource Management (RRM) for performing the control plane functions of the Alt.Arch.1 are first described. In the control plane of the Alt.Arch.1, the RRC protocol function is split into the MeNB 100 and the SeNB 200.

FIG. 2 is a diagram illustrating the control plane functions (RRC and RRM) performed by the MeNB 100 and the SeNB 200 in the Alt.Arch.1 for providing dual connectivity in accordance with an exemplary embodiment of the present invention.

Furthermore, Table 2 illustrates the RRC functions provided by the MeNB 100 and the SeNB 200 in the state in which the RRC functions are in an RRC_CONNECTED state.

In Table 2, functions that are included in the RRC functions and that are related to inter Radio Access Technology (inter-RAT) are excluded. In Table 2, “X” denotes that a corresponding RRC function is present in the MeNB 100 or the SeNB 200.

TABLE 2

| | RRC Functions | | MeNB | SeNB |
|---|---|---|---|---|
| System | NAS information | | X | |
| information | Information for UEs in RRC_CONNECTED | | X | X |
| broadcast | | | | |
| RRC | Paging | | X | |
| connection | Establish/ | Assignment/modification of UE identity | X | |
| control | modification/ | Establishment/modification/release of | X | X |
| | release of RRC | SRB1 and SRB2 | | |
| | connection | Access barring | X | |
| | Initial security | Initial configuration of AS integrity | X | X |
| | activation | protection (SRBs) | | |
| | | AS ciphering (SRBs, DRBs) | X | X |
| | RRC connection | Intra-frequency and inter-frequency | X | |
| | mobility | handover | | |
| | | Security handling | X | |
| | | (key/algorithm change) | | |
| | | RRC context information transfer | X | |
| | Establish/ | | X | X |
| | modification/ | | | |
| | release of DRBs | | | |
| | Radio | Assignment/modification of ARQ | X | X |
| | configuration | configuration | | |
| | control | HARQ configuration | X | X |
| | | DRX configuration | X | X |
| | QoS control | Assignment/modification of SPS | X | |
| | | configuration | | |
| | | Assignment/modification of parameters | X | X |
| | | for UL rate control in UE | | |
| | Recovery from | | X | |
| | radio link | | | |
| | failure | | | |

| | | |
|---|---|---|
| Measurement | Establish/modification/release of measurement | X |
| configuration | Setup and release of measurement gaps | X |
| and reporting | Measurement reporting | X |
| Other | Transfer of dedicated NAS information and | X |
| functions | non-3GPP dedicated information | |
| | Transfer of UE radio access capability information | X |

Referring to Table 2, system information broadcasted by the RRC functions include Non-Access Stratum (NAS) information, and information for the UE 300 in the idle and RRC_CONNECTED states of an Access Stratum (AS). Accordingly, the NAS information transferred through the S1-MME is transferred using the MeNB 100, and the information related to the AS may be transferred by taking into consideration the following methods.
A method of transferring system information related to the AS of the SeNB 200 to the UE 300 using the MeNB 100. This is a method of transferring system information to all pieces of the UE 300 in a dual connectivity state using a dedicated radio bearer-based RRC message. Such a method has an advantage in that the system information received by the UE 300 can be easily managed, but has disadvantages in that signaling is increased because system information is transferred based on a dedicated radio bearer and radio resources for the signaling are inevitably used.
A method of transferring system information related to the AS of the SeNB 200 to the UE 300 using the SeNB 200. This is a method of independently receiving, by the UE 300, pieces of system information broadcasted by the MeNB 100 and the SeNB 200. Such a method has an advantage in that dedicated radio bearer-based signaling is not required to transfer the system information, but has a disadvantage in that the UE 300 has to operate in conjunction with each eNB in order to obtain the system information.

In the Alt.Arch.1 in accordance with an exemplary embodiment of the present invention, when the SeNB 200 is initially added, the MeNB 100 transfers the system information of the SeNB 200 to the UE 300 through dedicated signaling. After the SeNB 200 is added, the UE 300 receives information broadcasted by the SeNB 200 and obtains the system information of the SeNB 200.

Referring to Table 2, the dual connectivity configuration of the wireless communication system relates to an operational procedure for the UE 300 in the RRC_CONNECTED state, and thus the establishment, modification, and release of RRC connection may be chiefly performed by the MeNB 100. In the Alt.Arch.1, however, an RRC protocol procedure for a specific Data Radio Bearer (DRB) is performed by the SeNB 200, and thus the establishment, modification, and release of a Signaling Radio Bearer (SRB) for the RRC protocol procedure may also be performed by the SeNB 200. In such a case, the SRB may basically become an SRB.

Furthermore, referring to Table 2, initial security activation is a procedure for the integrity protection and ciphering control of an SRB and a DRB. The initial security activation may be performed by the MeNB 100 and the SeNB 200 in which an SRB and a DRB are configured. Furthermore, the initial security activation of an Evolved-Universal Mobile Telecommunication System (UTMS) Terrestrial Radio Access Network (E-UTRAN) is performed through the exchange procedure of a SecurityModeCommand message and a SecurityModeComplete message, that is, RRC messages. That is, the eNB transfers the SecurityModeCommand message, including an integrity protection/encryption algorithm to be used for the communication of the AS, to the UE 300. In response to the SecurityModeCommand message, the RRC of the UE 300 configures a PDCP using information presented by the SecurityModeCommand message, and then transfers the SecurityModeComplete message to the eNB as a response message. AS security-related key information used in the UE 300 and the eNB include K_{eNB}, K_{RRCint}, K_{RRCenc}, and K_{UPenc}. The pieces of information may be generated based on K_{ASME} derived from a key included in the USIM of the UE 300 or the authentication centre (AuC) of a network. K_{ASME} is activated when NAS security mode is set prior to the setting of AS security mode. The UE 300 and the eNB may derive K_{eNB}, that is, an AS security key, based on K_{ASME}, and may derive K_{RRCint}, K_{RRCenc} and K_{UPenc} using a key derivation function.

In the Alt.Arch.1 for providing dual connectivity in accordance with an exemplary embodiment of the present invention, a method related to security activation may be taken into consideration as follows.

The exchange of pieces of security control information through the interoperation of the MeNB 100/the SeNB 200 may be performed through the steps of:
deriving, by the MeNB 100, a Next Hop (NH) based on K_{enb} of the MeNB 100 and deriving K_{enb*} of the SeNB 200 based on SeNB information (PCI, DL carrier frequency),
transferring, by the MeNB 100, the derived K_{enb*} of the SeNB 200,
deriving, by the SeNB 200, K_{RRCint}, K_{RRCenc}, and K_{UPenc} from K_{enb*} using the key derivation function,
exchanging, by the SeNB 200, integrity protection/encryption algorithms with the UE 300 through an RRC connection reconfiguration procedure, and
configuring, by the SeNB 200 and the UE 300, a PDCP using pieces of AS security-related information exchanged through the RRC connection reconfiguration procedure.

Referring to Table 2, RRC connection mobility is managed by the MeNB 100 by taking mobile robustness into consideration. Furthermore, the management (establishment, modification, and release) of DRBs may be performed by the MeNB 100 or the SeNB 200 under the control of the MeNB 100. That is, the management (establishment, modification, and release) of DRBs may be performed by the MeNB 100 or the SeNB 200 under the control of the MeNB 100 according to the status of eNB or a service request of UE 300 because the DRB is a radio bearer for the transmission/reception of user traffic.

Furthermore, in Table 2, the radio configuration control relates to control of the configuration of a protocol under the two layers of the eNB. In the Alt.Arch.1, the radio configuration control operates in response to a request from the RRC, and may be performed in the MeNB 100 and in the SeNB 200 in which an SRB and a DRB are configured.

The QoS control includes a function for configuring Semi-Persistent Scheduling (SPS) and the rate control function for the uplink of the UE 300. The SPS is used to schedule the service of a packet having a smaller size than a specific inter-arrival time, such as a Voice over Internet Protocol (VoIP). In the Alt.Arch.1, service using SPS is provided through the MeNB 100 whose service according to a modification of an SeNB is not interrupted and which easily guarantees Quality of Service (QoS). The uplink rate control function of the UE 300 may be configured based on each radio bearer. In the Alt.Arch.1, such a function may be provided by the MeNB 100 or the SeNB 200.

A Radio Link Failure (RLF) means that a radio link has been lost because an error has occurred in the RLC, MAC, and PHY, and may be recovered through an RRC connection re-establishment procedure. In the Alt.Arch.1, a parameter configuration function for detecting an RLF may be performed based on system information provided by the MeNB 100 and the SeNB 200. If an RLF occurs, the UE 300 performs a procedure for recovering the RLF through an RRC connection re-establishment procedure along with the MeNB 100 or the SeNB 200.

The measurement (measurement configuration and report procedure) of the UE 300 may be controlled by the MeNB 100 configured to perform a mobility management function in order to guarantee the mobility of the UE 300. The MeNB 100 gives an instruction for configuring measurement related to the MeNB 100 and the SeNB 200 to the UE 300. The UE 300 performs the measurement in response to the instruction of the MeNB 100. If a specific event occurs as a result of the measurement of the UE 300, the UE 300 reports information about the generated specific event to the MeNB 100 (i.e., a measurement report). After receiving the measurement report from the UE 300, the MeNB 100 controls an operational procedure suitable for the reported event.

Referring to Table 2, the exchange of pieces of dedicated NAS information, the exchange of pieces of non-3GPP-dedicated information, and the pieces of capability information of the UE 300 for sharing an E-UTRAN may be performed by the MeNB 100 because such exchanges correspond to a procedure for exchanging pieces of information between the MME and the UE 300.

Table 3 defines the RRM functions other than the inter-RAT-related function in the control plane of the Alt.Arch.1.

TABLE 3

| | Main functions | MeNB | SeNB |
|---|---|---|---|
| Radio | Establishment, maintenance, and | X | X |
| Bearer | release of radio bearers | | |
| Control | | | |
| Radio | Admission or rejection of | X | X |
| Admission | establishment requests for new | | |
| Control | radio bearers | | |
| Connection | Management of radio resources in | X | |
| Mobility | connection with idle and connected | | |
| Control | mode mobility | | |
| Dynamic | Allocation and de-allocation of | X | X |
| Resource | resource to user and control | | |
| Allocation | plane packets | | |
| Inter-cell | Management of radio resources such | X | X |
| Interference | that inter-cell interference is | | |
| Coordination | kept under control | | |
| Load | Handling of uneven distribution of | X | |
| Balancing | the traffic load over multiple cells | | |

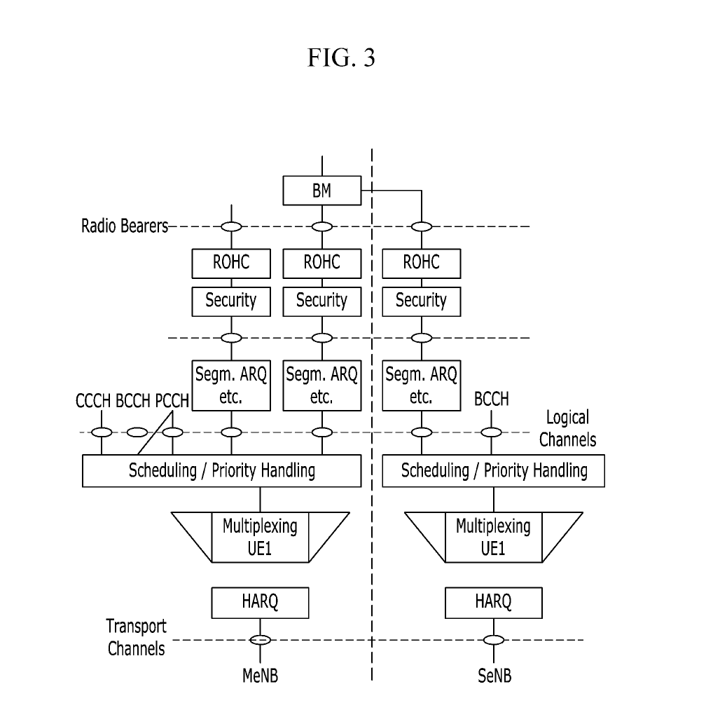

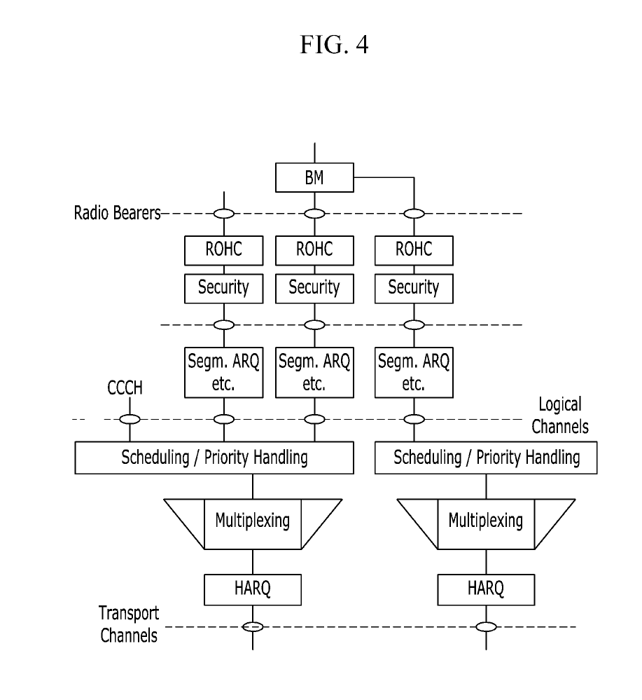

FIG. 3 is a diagram illustrating a protocol stack of user plane downlink in the wireless communication system for providing dual connectivity in accordance with an exemplary embodiment of the present invention, and FIG. 4 is a diagram illustrating a protocol stack of user plane uplink in the wireless communication system for providing dual connectivity in accordance with an exemplary embodiment of the present invention.

In the user plane of the Alt.Arch.1, the 2-layer protocols (i.e., the PDCP, RLC, and MAC) and the physical layer (PHY) may be independently placed in the MeNB 100 and the SeNB 200. Accordingly, in the Alt.Arch.1, a split point of the user plane for providing dual connectivity may become a layer above a PDCP.

In the Alt.Arch.1, in order to transfer user traffic between the MeNB 100 and the SeNB 200, user traffic needs to be split or merged in a layer above a PDCP under the control of the control plane. To this end, an exemplary embodiment of the present invention introduces a Bearer Management (BM) function for performing the following functions.

First, a BM function performed by the MeNB 100 is described. The MeNB 100 may generate a downlink BM Packet Data Unit (PDU) by processing a Service Data Unit (SDU) received from the S1-U, and may deliver the generated PDU to the radio bearer of the MeNB 100 or the SeNB 200. Furthermore, the MeNB 100 may process an uplink BM PDU received from the radio bearer of the MeNB 100 or the SeNB 200, and may deliver the processed PDU to the S1-U. Furthermore, the MeNB 100 may buffer and forward a user plane downlink BM PDU according to an SeNB change procedure. In the case of a bearer split, order of uplink BM PDUs may be reordered, and the reordered uplink BM PDUs may be delivered in sequence. Furthermore, a downlink packet may be routed based on information about a flow control configuration.

A BM function performed by the UE 300 is described below. The UE 300 may generate an uplink BM PDU by processing an SDU received from an application, and may deliver the generated PDU to the radio bearer of the MeNB 100 or the SeNB 200. Furthermore, the UE 300 may deliver a downlink BM PDU, received from the radio bearer of the MeNB 100 or the SeNB 200, to the application. Furthermore, the UE 300 may buffer and forward a user plane uplink PDU according to an SeNB change procedure. In the case of a bearer split, the UE 300 may reorder the order of downlink BM PDUs, and may deliver the reordered downlink BM PDUs in sequence. Furthermore, the UE 300 may route an uplink packet based on information about a flow control configuration.

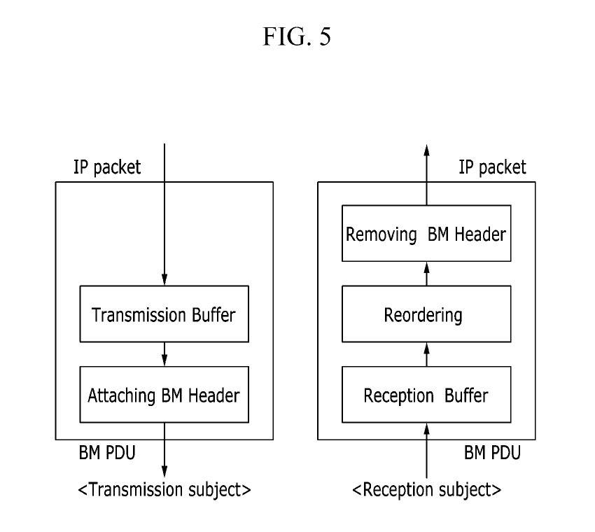

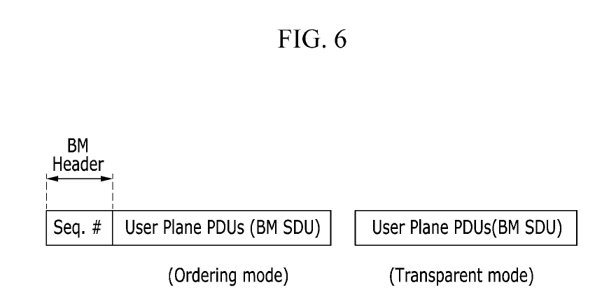

In accordance with an exemplary embodiment of the present invention, if a bearer of an Evolved Packet System (EPS) (an EPS bearer) is split into a plurality of radio bearers, the following BM method may be taken into consideration for the sequential reordering and in-sequence delivery of BM PDUs. FIG. 5 is a diagram illustrating a case where a BM operates as an OM in accordance with an exemplary embodiment of the present invention, and FIG. 6 is a diagram illustrating an OM PDU and a TM PDU according to the operation of a BM in accordance with an exemplary embodiment of the present invention.
Ordering Mode (OM)-based reordering and in-sequence delivery: this is a method of transmitting/receiving uplink/downlink data through a BM PDU in which information about a header including a sequence number has been added to the SDU transferred to the BM. The OM-based reordering and in-sequence delivery method may be used when a bearer split occurs. Such a method is disadvantageous in that it requires additional radio resources for all the BM PDUs, and transmission overhead is increased because the BM PDUs each include a BM header are transmitted.
Transparent Mode (TM)-based reordering and in-sequence delivery: this is a method of adding no information about a header to an SDU transferred to the BM and transmitting/receiving uplink/downlink data. The TM-based reordering and in-sequence delivery method may be used when a bearer split does not occur. Such a method is advantageous in that additional radio resources for a BM PDU are not required because the BM PDU not including a BM header is transmitted.

In accordance with an exemplary embodiment of the present invention, BM may operate as OM for the in-sequence delivery of BM PDUs delivered to the MeNB 100 and the SeNB 200 if a bearer split is not generated in the MeNB 100, and may operate as TM if a bearer split is generated in the MeNB 100. If BM operates as OM, the MeNB 100 or the UE 300 performs an ordering and in-sequence delivery procedure in a sliding window manner using the sequence number of BM PDUs. If BM operates as TM, the MeNB 100 or the UE 300 does not perform the reordering and in-sequence delivery procedure.

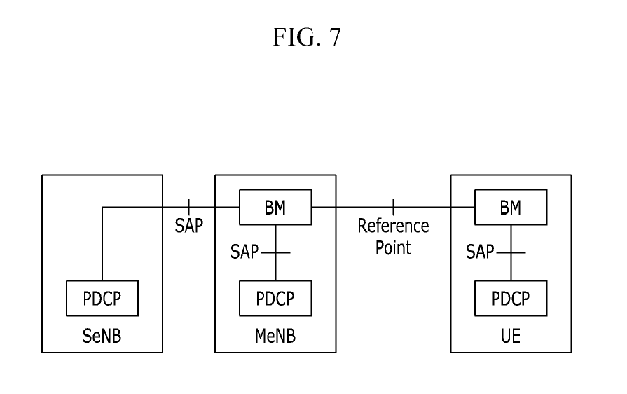

FIG. 7 is a diagram illustrating the interoperation structure of a BM in accordance with an exemplary embodiment of the present invention.

Referring to FIG. 7, the BM is placed in a layer above the PDCPs of the MeNB 100 and the UE 300. That is, the BM of the MeNB 100 may operate in conjunction with the PDCP of the MeNB 100 or the PDCP of the SeNB 200, and the BM of the UE 300 may operate in conjunction with the PDCP of the UE 300.

In the Alt.Arch.1 in accordance with an exemplary embodiment of the present invention, since the MeNB 100 and the SeNB 200 independently include the PDCPs, there is a need for a definition regarding the operational procedure of a PDCP related to security. In such a case, a method written in the RRC functions described with reference to Table 2 may be used. If the method written in the RRC functions is used, the MeNB 100 transfers the key K_{enb*} of the SeNB 200 for a radio bearer for dual connectivity to the SeNB 200. The SeNB 200 that has received the key K_{enb*} of the SeNB 200 selects an integrity protection and ciphering algorithm. The SeNB 200 that has selected the integrity protection and ciphering algorithm performs an RRC connection reconfiguration procedure along with the UE 300, and then performs a security-related PDCP configuration procedure using the RRC function of the SeNB 200. Furthermore, the SeNB 200 processes the data of a radio bearer for supporting dual connectivity.

Meanwhile, in the Alt.Arch.1 in accordance with an exemplary embodiment of the present invention, the MeNB 100 and the SeNB 200 include independent MAC protocols. In the Alt.Arch.1, a technical issue related to dual connectivity MAC is a procedure related to a channel mapping configuration and uplink/downlink radio resource allocation.

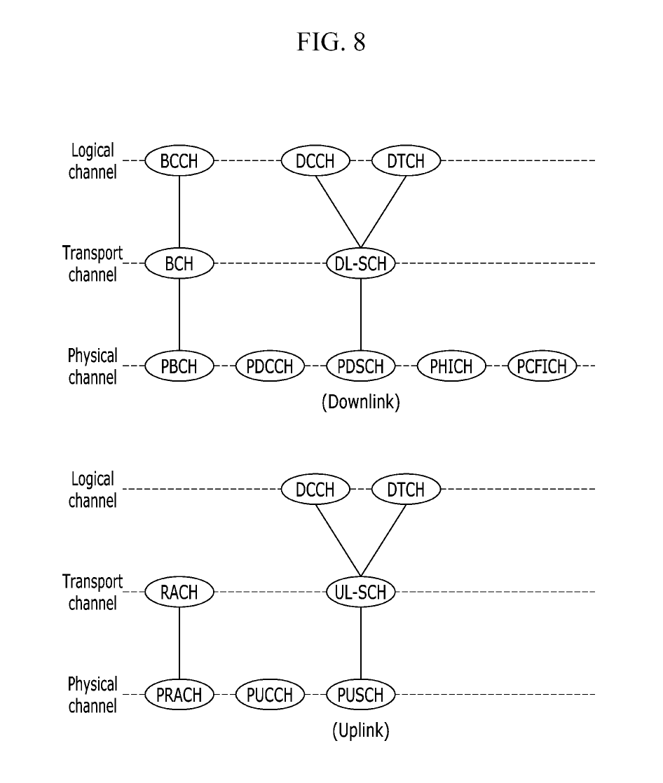

FIG. 8 is a diagram illustrating a channel mapping configuration for the dual connectivity of the SeNB 200 of the Alt.Arch.1 in accordance with an exemplary embodiment of the present invention.

Referring to FIG. 8, in downlink, a dedicated control channel, a dedicated traffic channel, and a broadcasting channel may be supported. Furthermore, in uplink, a dedicated control channel, a dedicated traffic channel, and a random access channel may be supported.

The MeNB 100 and the SeNB 200 provide dual connectivity manage independent schedulers configured to perform respective radio resource allocation functions in uplink and downlink, and may operate as follows.
Downlink radio resource allocation and scheduling: in order to allocate downlink radio resources, the MAC layer of each of the MeNB 100 and the SeNB 200 may perform scheduling based on information about a downlink buffer and information about a downlink channel state that is reported by the UE 300. In the Alt.Arch.1 in accordance with an exemplary embodiment of the present invention, each of the MeNB 100 and the SeNB 200 that provides dual connectivity may include an independent MAC protocol and scheduler, and may perform a downlink radio resource allocation procedure using Channel State Information (CSI) (e.g., Channel Quality Indicator (CQI), a Precoding Matrix Index (PMI), and a Rank Index (RI)), such as a downlink buffer state of an RLC level, a CQI received from the UE 300, and an RI.
Uplink radio resource allocation: in order to allocate uplink radio resources to the UE 300, the Scheduling Request (SR) procedure, the Power Headroom Report (PHR) procedure, and the Buffer Status Report (BSR) procedure of the MAC layer are required.

The SR procedure is a procedure in which the UE 300 requests the eNB to allocate radio resources for new uplink transmission. To this end, the UE 300 sends a Physical Uplink Control Channel (PUCCH), including an SR, to the eNB (i.e., the MeNB 100 or the SeNB 200) in which the RRC that has configured a corresponding radio bearer is placed.

In the Alt.Arch.1 in accordance with an exemplary embodiment of the present invention, the MAC of each UE may transmit the SR to the MeNB 100 or SeNB 200.

Furthermore, the PHR procedure is a procedure in which the UE 300 delivers a difference between the maximum transmit power of the UE 300 and an power estimation required for uplink transmission to the eNB. To this end, the UE 300 performs the PHR procedure along with the MeNB 100 and the SeNB 200. In this case, PHR information V_{PHR} reported to the eNB is a difference between the sum of a power estimation Pₘ for the UL-SCH and PUCCH transmission of the MeNB 100, and a power estimation Pₛ for the UL-SCH and PUCCH transmission of the SeNB 200 and the maximum transmission power Pₘₐₓ. In this case, the PHR information may be transferred to the eNB using a MAC Control Element (CE). The PHR information transferred in uplink through the PHR procedure may be defined as follows.

V_{PHR}=Pₘₐₓ−(Pₘ+Pₛ) (Equation 1)

Furthermore, the BSR procedure is a procedure in which the UE 300 transfers an uplink buffer state to the eNB.

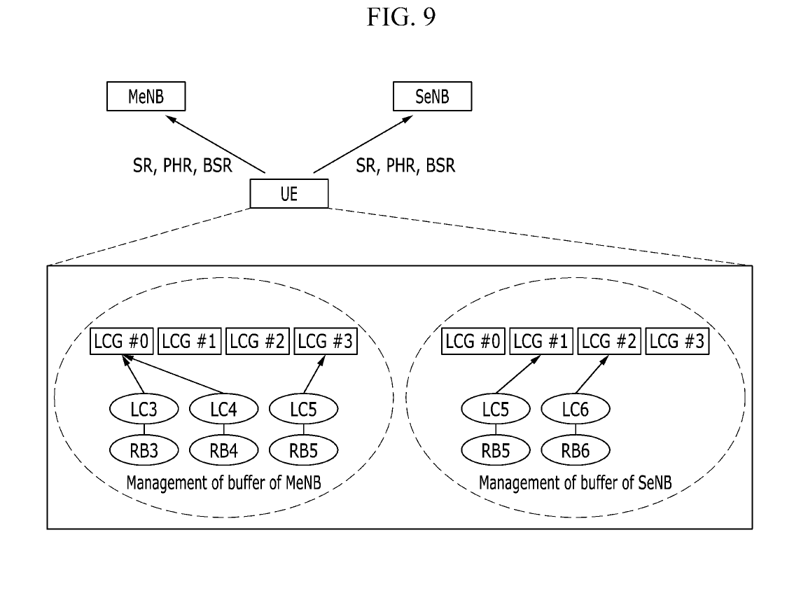

FIG. 9 is a diagram illustrating the buffer management structure of the UE in accordance with an exemplary embodiment of the present invention.

Referring to FIG. 9, the UE 300 transfers a MAC CE, including information about a BSR, to the eNB (i.e., the MeNB 100 or the SeNB 200) in which the RRC that has configured a corresponding radio bearer is placed for the purpose of the BSR procedure. In the Alt.Arch.1 in accordance with an exemplary embodiment of the present invention, the UE 300 manages a Logical Channel Group (LCG) based on radio bearers/logical channels configured for each MeNB 100 or SeNB 200 for the purpose of the BSR procedure for dual connectivity, and performs the BSR (e.g., a short BSR, long BSR, or truncated BSR) procedure along with the MeNB 100 or the SeNB 200 based on the LCG.
Logical Channel Prioritization (LCP): the UE 300 to which uplink radio resources have been allocated through an uplink scheduling procedure configures a MAC PDU through an LCP procedure. The LCP procedure for dual connectivity may be performed using a Prioritized Bit Rate (PBR) and a Bucket Size Duration (BSD), that is, the attributes of each radio bearer, based on the radio bearer allocated for each MeNB 100 or SeNB 200. The UE 300 generates an uplink MAC PDU through such an LCP procedure.

Meanwhile, the downlink data traffic (e.g., traffic transferred by the S-GW through the 51-U) of the Alt.Arch.1 in accordance with an exemplary embodiment of the present invention may be transferred to the UE 300 using the downlink radio resources of the MeNB 100 or the SeNB 200 under the control of the RRC/BM of the MeNB 100. Furthermore, uplink data traffic for dual connectivity may be transferred to the MeNB 100 or the SeNB 200 using uplink radio resources under the control of the RRC/BM of the UE 300. Accordingly, a data transfer function and a flow control function between the MeNB 100 and the SeNB 200 are required in downlink of the wireless communication system for supporting dual connectivity, and a flow control function between the MeNB 100 and the SeNB 200 are required in uplink of the wireless communication system for supporting dual connectivity.

In the wireless communication system for providing dual connectivity in accordance with an exemplary embodiment of the present invention, the MeNB 100 and the SeNB 200 operate in conjunction with the UE 300 using independent 2-layer protocols. Particularly, the MeNB 100 and the SeNB 200 allocate uplink/downlink radio resources using respective MAC schedulers. The MAC scheduler placed in each eNB allocates DL assignment and a UL grant based on information about the RLC buffer and the state of the radio channel of the UE 300. In the Alt.Arch.1, since downlink data is transferred by the BM of the MeNB 100, a function for variably controlling the amount of traffic transferred between the MeNB 100 and the SeNB 200 by taking into consideration a change in the state of a radio channel between the MeNB 100 and the SeNB 200 and the UE 300 is required.

In order to solve such a downlink traffic flow control problem, the MeNB 100 and the SeNB 200 may perform flow control for the transfer of traffic by the MeNB 100 and the SeNB 200 through such a method and procedure. Downlink traffic flow control is performed when data is transferred using the SeNB 200 regardless of a bearer split.
A downlink flow control method D1: using the control plane protocol

In such a method, the RRC of the MeNB 100 performs flow control for the transfer of traffic between the MeNB 100 and the SeNB 200. In accordance with the method, when configuring a radio bearer, the RRC of the MeNB 100 sets the flow control-initial value of the corresponding radio bearer in the BM. The RRC of the MeNB 100 dynamically performs flow control based on a report on a downlink buffer state from the SeNB 200 under the control of the BM while service is provided. If such a method is performed, a flow control-related protocol procedure between the MeNB 100 and the SeNB 200 is performed through an Xn-CP.
A downlink flow control method D2: using the user plane protocol

In such a method, the BM of the MeNB 100 performs flow control for the transfer of traffic between the MeNB 100 and the SeNB 200. In accordance with the method, when the RRC configures a radio bearer, the MeNB 100 sets the flow control-initial value of the corresponding radio bearer in the BM, and dynamically performs flow control by controlling the BM of the MeNB 100 based on a report on a downlink buffer state from the SeNB 200 while service is provided. If such a method is performed, a flow control-related protocol procedure between the MeNB 100 and the SeNB 200 is performed through the Xn-UP.

A method of performing, by the MeNB 100 and the SeNB 200, flow control for the transfer of traffic using the “downlink flow control method D1” is described below.

First, when configuring a downlink radio bearer for dual connectivity, the RRC of the MeNB 100 sets an initial value for the flow control of a downlink packet, transferred to the MeNB 100 and the SeNB 200, in the BM (an initial setting step for the BM). In this case, the initial value may be set by taking into consideration the QoS characteristic of a radio bearer configured in the MeNB 100 and the SeNB 200. The BM processes a downlink packet based on a packet flow setting value set when a radio bearer is initially configured. In this case, the packet flow setting value may be set in accordance with the following method. In order to perform flow control on the downlink packet, the setting value of the MeNB 100 and the SeNB 200 may be defined as fcm.d or fcs.d, and the sum of the values fcm.d and fcs.d is set to 1. The BM may derive the size of the downlink packet transferred to the MeNB 100 and the SeNB 200 by multiplying the value of fcm.d or fcs.d, presented by the RRC, by a maximum data rate transferred by a corresponding radio bearer. The MeNB 100 and the SeNB 200 may transfer the downlink packet based on the derived size of the downlink packet.

Thereafter, the SeNB 200 reports the downlink buffer state to the MeNB 100 (a downlink buffer state report step). That is, after the radio bearer is configured, the RRC of each of the MeNB 100 and the SeNB 200 checks the state of the downlink PDCP transfer buffer periodically or when an event is generated. In order to perform such a procedure, the RRC performs a configuration procedure related to a report on the state of the PDCP transfer buffer along with the PDCP when the radio bearer is configured. Such a configuration may be divided into a periodical report and a report on the occurrence of an event based on the upper/lower threshold value of the PDCP transfer buffer. Furthermore, in order to report the downlink buffer state, the RRC placed in the SeNB 200 reports the state of the downlink PDCP transfer buffer, received from the PDCP, to the RRC of the MeNB 100 using a protocol message (e.g., using a resource status update message or defining a new message) on the Xn-CP.

Thereafter, each of the MeNB 100 and the SeNB 200 reconfigures a flow control function in response to a change in the state of the downlink packet buffer (a flow control function reconfiguration step). That is, the RRC of each of the MeNB 100 and the SeNB 200 that have received the state of the downlink packet buffer reconfigures the set value for the flow control of a downlink packet, transferred to the MeNB 100 and the SeNB 200, again through a BM reconfiguration procedure. After the RRC performs the BM reconfiguration procedure, the BM processes the downlink packet using the newly set packet flow setting value.

A method of performing, by the MeNB 100 and the SeNB 200, flow control for the transfer of traffic using the aforementioned “method D2” is described below.

First, when a downlink radio bearer for dual connectivity is configured, a step of initially configuring the BM is the same as the first step of the “method D1”. In this case, in the “method D1”, the value of fcm.d or fcs.d is dynamically set again according to the BM reconfiguration procedure of the RRC. In the “method D2”, however, the BM may autonomously perform a flow control procedure in response to a report from the SeNB 200.

Thereafter, the SeNB 200 reports the downlink buffer state to the MeNB 100 (a downlink buffer state report step). After the radio bearer is configured, the Xn-UP of the MeNB 100 and the SeNB 200 check the state of the downlink PDCP transfer buffer periodically or when an event occurs. In order to perform such a procedure, the RRC of each eNB performs a configuration procedure related to a report on the state of the downlink PDCP transfer buffer on the PDCP when the radio bearer is configured. In accordance with the “method D2”, the PDCP of the SeNB 200 transfers the state of the downlink PDCP transfer buffer to the Xn-UP of the SeNB 200 periodically or based on a threshold value. The Xn-UP of the SeNB 200 transfers the corresponding information to the MeNB 100 through a management message based on the state of the downlink PDCP transfer buffer. In response to the Xn-UP management message, the MeNB 100 transfers the information about the downlink buffer state to the BM. For example, if a General packet radio service Tunneling Protocol (GTP)-User plane (U) is used as a user plane protocol for the transmission of data between the MeNB 100 and the SeNB 200, a GTP-U management message for the downlink buffer state report of the “method D2” may be newly defined, and pieces of information may be exchanged using the defined GTP-U management message.

Thereafter, each of the MeNB 100 and the SeNB 200 reconfigures the flow control function based on a change in the downlink buffer state (a flow function reconfiguration step). The BM dynamically sets a set value for the flow control of the downlink packet, transferred to the MeNB 100 and the SeNB 200, again based on the reports on the state of the downlink packet buffers of the MeNB 100 and the SeNB 200. Furthermore, the BM changes the set value for packet flow control and then processes the downlink packet using the newly set packet flow setting value.

Meanwhile, in order to solve an uplink traffic flow control problem, the UE 300 may perform flow control for the transfer of uplink traffic through the following method and procedure. The flow control for uplink traffic may be performed when a bearer split is generated, that is, if the uplink traffic transfer path of the UE 300 includes both the MeNB 100 and the SeNB 200.
An uplink flow control method U1: using the control plane protocol

Such a method is a method of performing, by the RRC of the UE 300, flow control for the transfer of uplink traffic. In accordance with this method, when the RRC configures a radio bearer, the RRC of the UE 300 may set the flow control-initial value of the corresponding radio bearer in the BM, and may perform a dynamic flow control procedure by controlling the BM based on a report on an uplink buffer state while service is provided.
An uplink flow control method U2: using the user plane protocol

In such a method, the BM of the UE 300 performs flow control for the transfer of uplink traffic. In accordance with the method, when the RRC configures a radio bearer, the RRC may set the flow control-initial value of the corresponding radio bearer in the BM, and may dynamically perform a flow control procedure based on a report on an uplink buffer state under the control of the BM while service is provided.

A method of performing, by the UE 300, flow control for the transfer of uplink traffic using the “method U1” is described below.

First, when configuring an uplink radio bearer for dual connectivity, the RRC of the UE 300 sets an initial value for the flow control of an uplink packet, transferred to the MeNB 100 and the SeNB 200, in the BM (a BM initial setting step). In this case, a PDCP configuration method for performing such a procedure is the same as the downlink configuration method. In this case, uplink parameters fc_{m.u} and fc_{s.u} may be used.

Next, the UE 300 reports the uplink buffer state to the BM (an uplink buffer state report step). After a radio bearer is configured, the RRC of the UE 300 checks the state of an uplink PDCP transfer buffer periodically or when an event occurs. A PDCP configuration method for performing such a procedure is the same as the downlink configuration method.

Furthermore, the UE 300 reconfigures the flow control function in response to a change in the state of an uplink packet buffer (a flow control function reconfiguration step). The BM of the RRC sets a set value for the flow control of a packet, transmitted in uplink, again through the BM reconfiguration procedure based on a report on the state of the uplink packet buffer. After the BM reconfiguration procedure of the RRC is performed, the BM processes the uplink packet using the newly set packet flow setting value.

A method of performing, by the UE 300, flow control for the transfer of uplink traffic using the aforementioned “uplink flow control method U2” is described below. First, when an uplink radio bearer is configured, the initial setting step of the BM is the same as the first step of the “method U1”.

Thereafter, the UE 300 reports the uplink buffer state to the BM (an uplink buffer state report step). That is, after a radio bearer is initially configured, the PDCP of the UE 300 reports the state of the uplink PDCP transfer buffer to the BM periodically or when an event is generated.

Thereafter, the UE 300 reconfigures the flow control function in response to a change in the uplink buffer state (a flow control function reconfiguration step). That is, the BM sets a set value for the flow control of a packet, transmitted in uplink, again through a reconfiguration procedure based on a report on the state of the uplink packet buffer. After performing the BM reconfiguration procedure, the BM processes the uplink packet using the newly set packet flow setting value.

Transfer between the MeNB 100 and the SeNB 200 of the wireless communication system for supporting dual connectivity in accordance with an exemplary embodiment of the present invention is described below.

A downlink BM PDU generated by the BM of the MeNB 100 is delivered to the PDCP of the MeNB 100 or the PDCP of the SeNB 200 under the control of the RRC. Particularly, if the downlink BM PDU is transferred using a radio bearer configured in the SeNB 200, there is a need for a mechanism for the transfer of data between the MeNB 100 and the SeNB 200. Furthermore, as in the transfer of the downlink BM PDU, an uplink BM PDU is also transferred through the MeNB 100 or the SeNB 200. Particularly, if the uplink BM PDU is transferred through a radio bearer configured in the SeNB 200, there is a need for a mechanism for the transfer of data between the MeNB 100 and the SeNB 200.

In the Alt.Arch.1 in accordance with an exemplary embodiment of the present invention, GTP-U+ in which an additional function for dual connectivity is added to the GTP-U protocol used in the existing Rel-11 may be used as an Xn-UP protocol in order to exchange data between the MeNB 100 and the SeNB 200.

The Xn-UP protocol needs to have a mechanism for guaranteeing QoS (i.e., a QoS parameter of an E-UTRAN Radio Access Bearer (E-RAB) level) according to the characteristics of a bearer for the transfer of traffic between the MeNB 100 and the SeNB 200. The Xn-CP is used to configure the Xn-UP protocol.

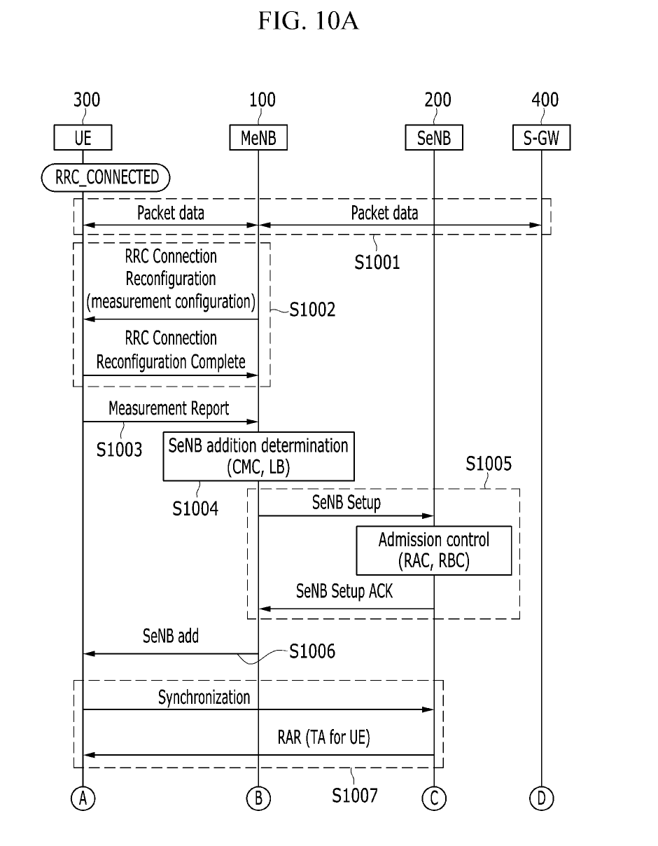

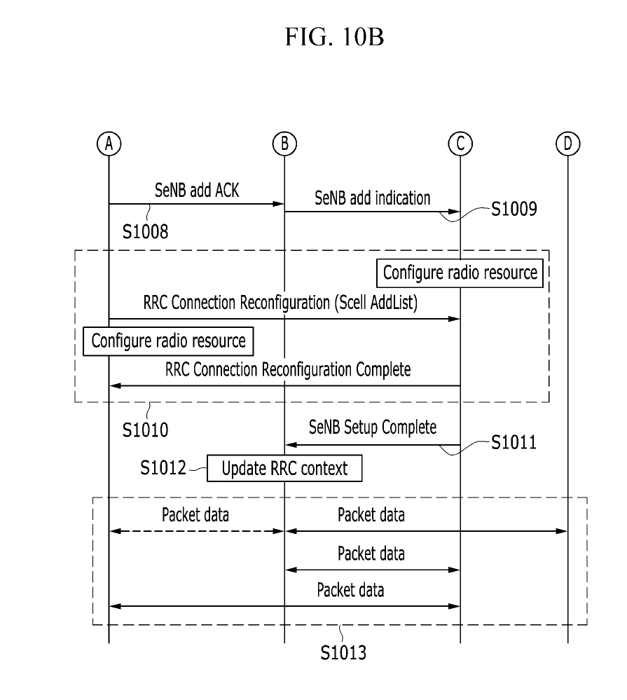

An operational procedure of the wireless communication system for dual connectivity is described below using the control plane and user plane structures of the Alt.Arch.1 with reference to FIGS. 10 to 16. The operational procedure of the Alt.Arch.1 in accordance with an exemplary embodiment of the present invention includes an SeNB addition procedure, an SeNB change procedure, an SeNB reconfiguration procedure, an SeNB release procedure, and an SeNB buffer state report procedure.

In the present invention, the RRC_CONNECTED state of the UE 300 is divided into a single connectivity state and a dual connectivity state and described. In the present invention, if the UE 300 performs communication using a DRB of the SeNB 200, it may be defined as the dual connectivity state regardless of the presence of a DRB of the MeNB 100. The reason for this is that an SRB is present in the MeNB 100 although a DRB is not present in the MeNB 100.

First, the addition procedure of the SeNB 200 is described below.

FIG. 10A and FIG. 10B are a flowchart illustrating the SeNB addition procedure of the Alt.Arch.1 in accordance with an exemplary embodiment of the present invention.

In the addition procedure of the SeNB 200, the SeNB 200 is added under the control of the MeNB 100, and dual connectivity is provided to the UE 300. The Alt.Arch.1 includes two types of addition procedures depending on a method of transferring an RRC message for adding the SeNB 200.

Method A1: the exchange of RRC connection reconfiguration-related messages using the SeNB

Method A2: the exchange of RRC connection reconfiguration-related messages using the MeNB and the SeNB

FIG. 10A and FIG. 10B illustrate the method A1. In the method A1, the MeNB 100 enables the UE 300 to perform uplink/downlink synchronization for the addition of the SeNB 200 that provides dual connectivity. When the synchronization is completed, the SeNB 200 may be added through a protocol between the RRC of the SeNB 200 and the RRC of the UE 300.

First, the UE 300 performs communication with the MeNB 100 based on the single connectivity with the MeNB 100. That is, the UE 300 is in the RRC_CONNECTED state. In such a state, the UE 300 performs initial access to the MeNB 100, and is provided with service through the MeNB 100 (a single connectivity-based communication step) at step S1001.

Thereafter, the MeNB 100 instructs the UE 300 to perform measurement for discovering the SeNB 200 through an RRC connection reconfiguration procedure. In response to the instruction of the MeNB 100, the UE 300 performs a measurement configuration (an SeNB measurement instruction step) at step S1002.

The UE 300 periodically performs measurement according to the configuration of the MeNB 100. If conditions set by the MeNB 100 are satisfied, the UE 30 reports this to the MeNB 100. At this step, the UE 300 may search for/discover a addable small cell, which is operated at same frequency or neighbor frequency, through the measurement procedure and may report the retrieved/discovered small cell, or may transfer information about the channel state between the UE 300 and the MeNB 100 to the MeNB 100 (a measurement report step) at step S1003.

Thereafter, the MeNB 100 determines whether or not to add the SeNB 200 by taking a load state of the MeNB 100 into consideration. In such a procedure, the UE 300 may configure a new bearer or change the path of a bearer already configured in the UE 300, or may perform simultaneous transmission using a plurality of bearers (an SeNB addition determination step) at step S1004.

The MeNB 100 requests the SeNB 200 to configure the SeNB based on the search result of the SeNB 200 performed by the UE 300 and the addition determination of the SeNB 200 performed by the MeNB 100. In this step, the MeNB 100 transfers an SeNB setup message, including at least one of information about a Cell-Radio Network Temporary Identifier (C-RNTI) of the UE 300 that provides dual connectivity, information (an SRB or DRB) about the attributes of a bearer to be configured, and the UE radio access capabilities of the UE 300, to the SeNB 200. In response to the SeNB setup message from the MeNB 100, the SeNB 200 performs an admission control procedure regarding whether or not the requested bearer has been configured through the Radio Admission Control (RAC) function of the RRM, and transfers an SeNB setup ACK message, including result code, to the MeNB 100 (an SeNB Setup request step) at step S1005.

Thereafter, the MeNB 100 transfers an SeNB addition message for uplink synchronization to the UE 300. The SeNB addition message includes information for non-contention-based random access and cause information for SeNB addition for uplink synchronization. In this case, the cause information included in the SeNB addition message is an initial setup. If contention-based-random access is indicated, preliminary information related to random access is not included in the SeNB addition message (an SeNB addition step) at step S1006.

The UE 300 performs a random access procedure along with the SeNB 200 using information for non-contention-based random access that is included in the SeNB addition message, and secures uplink synchronization. If contention-based-random access is indicated in the “SeNB addition step”, the UE 300 may perform a random access procedure according to the 3GPP TS 36.321 standard (an uplink synchronization step) at step S1007.

After performing the uplink synchronization acquisition procedure along with the SeNB 200, the UE 300 sends an addition ACK message to the MeNB 100 (an SeNB addition ACK step) at step S1008.

After the uplink/downlink synchronization acquisition of the UE are completed, the MeNB 100 transfers, to the SeNB 200, an SeNB addition indication message including information about the configuration of a user plane protocol (e.g., the Xn-U) for the transmission/reception of packets between the MeNB 100 and the SeNB 2001 and information about a key K_{enb*} for setting a security mode. In response to the SeNB addition indication message, the SeNB 200 starts a procedure for configuring the radio resources of the SeNB 200 (an SeNB addition indication step) at step S1009.

Furthermore, in response to the SeNB addition indication from the MeNB 100, the SeNB 200 performs a step of configuring the radio resources of the UE 300 and the SeNB 200 using an RRC connection reconfiguration procedure. Attribute information related to the requested radio bearer and algorithm information related to security may be exchanged through such a procedure when the SeNB setup request step is performed. Particularly, the attribute information related to the radio bearer transferred when the SeNB setup request step is performed includes information about an SRB for transferring an RRC message and information about a Data Radio Bearer (DRB) for transferring user traffic. An SRB configuration procedure for the exchange of protocol messages between the SeNB 200 and the UE 300 and a radio resource configuration procedure for a DRB may be performed using the information about the SRB and the information about the DRB. After completing the radio resource configuration procedure between the SeNB 200 and the UE 300, the SeNB 200 configures a user plane protocol for the transmission/reception of packets between the MeNB 100 and the SeNB 200 using the Xn-U configuration information received through the SeNB addition indication message (a radio resource configuration step for SeNB addition) at step S1010.

Furthermore, after performing the RRC connection reconfiguration procedure, the SeNB 200 transfers an SeNB setup complete message to the MeNB 100 (an SeNB setup complete step) at step S1011.

In response to the SeNB setup complete message from the SeNB 200, the MeNB 100 changes the RRC context of the UE 300 into the dual connectivity state (an RRC context update step) at step S1012.

Thereafter, the UE 300 performs a communication procedure through the radio bearer configured through the SeNB 200 and the radio bearer configured through the MeNB 100 (dual connectivity-based communication step) at step S1013.

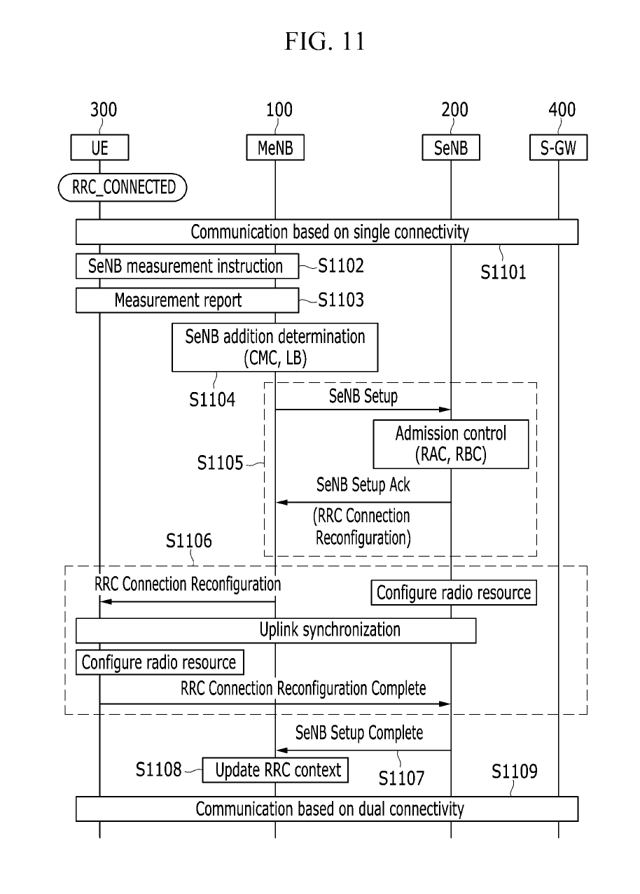

FIG. 11 is a flowchart illustrating an SeNB addition method in the Alt.Arch.1 in accordance with another exemplary embodiment of the present invention.

That is, FIG. 11 illustrates the method A2. Referring to FIG. 11, in the addition method (i.e., the method A2) of the SeNB 200 in accordance with another exemplary embodiment of the present invention, a single connectivity-based communication step S1101, an SeNB measurement indication step S1102, a measurement report step S1103, and an SeNB addition determination step S1104 may be performed in the same manner as the method A1.

Thereafter, the MeNB 100 requests the SeNB 200 to set up the SeNB based on the search result of the SeNB performed by the UE 300 and the addition determination of the SeNB performed by the MeNB 100. For such a step, the MeNB 100 transfers an SeNB setup message, including information about the C-RNTI of the UE 300 that provides dual connectivity, information about the configuration of the Xn-U, information about a key K_{enb*} for setting security mode, and information about the attributes of a bearer to be configured, to the SeNB 200. Furthermore, in response to the SeNB setup message from the MeNB 100, the SeNB 200 performs an admission control procedure regarding whether a requested bearer has been configured through the RAC of the RRM. If a requested configuration is accepted, the SeNB 200 generates an RRC connection configuration message for SeNB addition. The RRC connection configuration message generated by the SeNB 200 may be transferred to the MeNB 100 as an SeNB setup ACK message including a result code (an SeNB addition setup request step) at step S1105.

After sending the SeNB setup ACK message to the MeNB 100, the SeNB 200 performs a radio resource configuration procedure on the SRB and DRB of the SeNB 200 of the requested SeNB addition is accepted. Furthermore, in response to the SeNB setup ACK message for SeNB addition from the SeNB 200, the MeNB 100 extracts an RRC connection reconfiguration message from the SeNB setup ACK message and sends the RRC connection reconfiguration message to the UE 300. In response to the RRC connection reconfiguration message for SeNB addition from the MeNB 100, the UE 300 performs an uplink synchronization procedure, performs a radio resource configuration procedure, and transfers an RRC connection reconfiguration complete message to the SeNB 200 (a radio resource configuration step for SeNB addition) at step S1106.

Thereafter, the setup of the SeNB 200 is completed, and the same steps (i.e., an SeNB setup complete step, an RRC context update step, and a dual connectivity-based communication step) (S1107 to S1109) as those of the method A1 may be performed in the method A2.

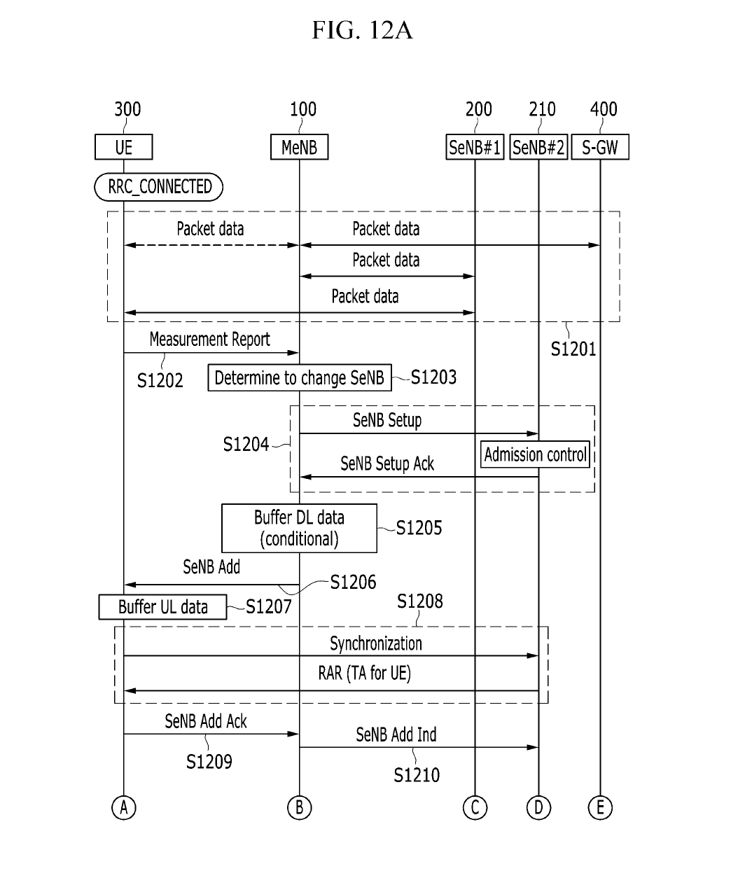

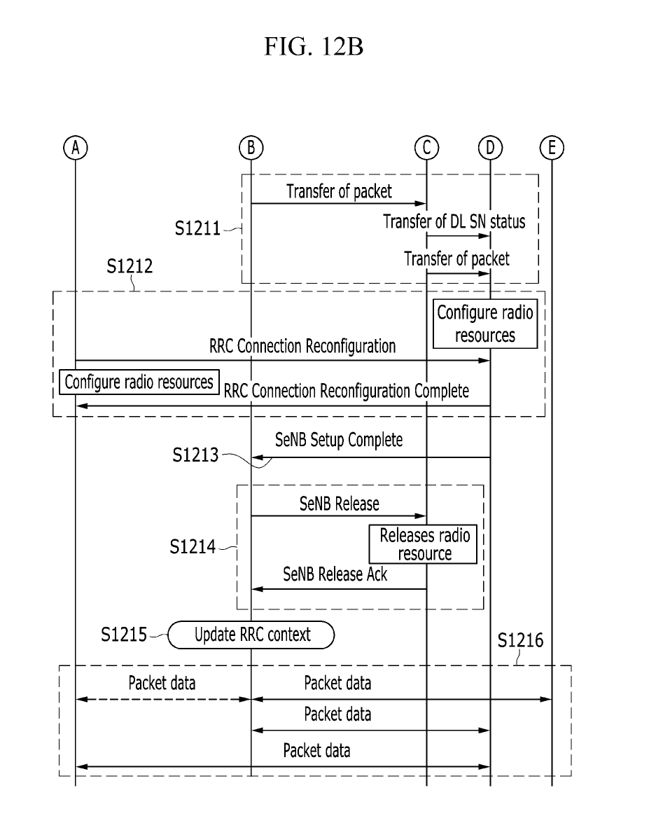

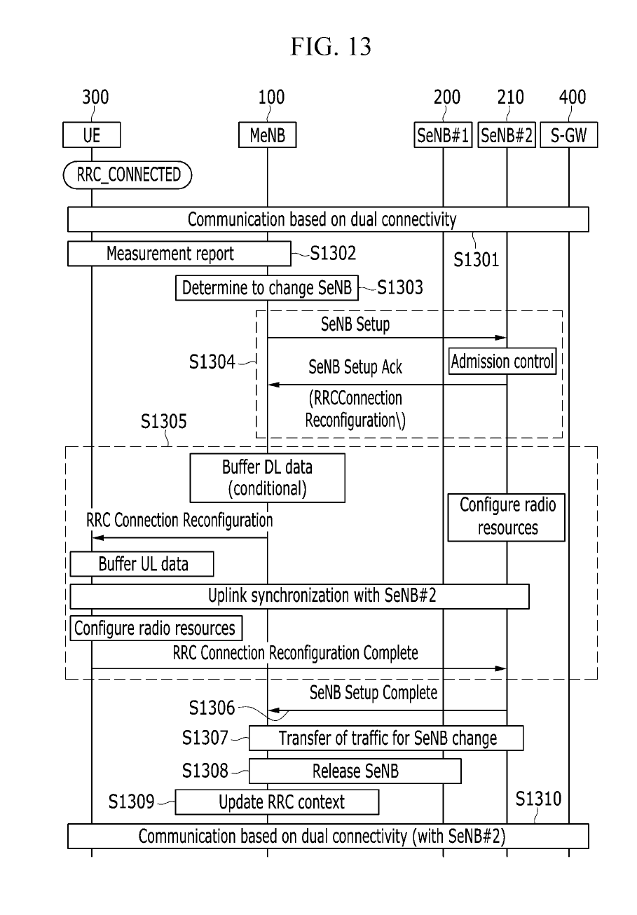

FIGS. 12A, 12B and 13 are flowcharts illustrating a method of changing an SeNB in accordance with an exemplary embodiment of the present invention.

The SeNB change procedure of the Alt.Arch.1 in accordance with an exemplary embodiment of the present invention relates to a change of the SeNB 200 that provides dual connectivity to the UE 300 under the control of the MeNB 100. In the Alt.Arch.1, as in the addition procedure of the SeNB 200, the following two methods may be used depending on a method of transferring an RRC message for changing the eNB.

Method C1: the exchange of RRC connection reconfiguration messages using an SeNB

Method C2: the exchange of RRC connection reconfiguration messages using an MeNB and an SeNB

In accordance with the method C1, the MeNB 100 enables the UE 300 to perform uplink/downlink synchronization in order to add the SeNB 200 that provides dual connectivity. When the UE 300 completes the uplink/downlink synchronization, a protocol procedure may be performed between the RRC of the SeNB 200 and the RRC of the UE 300, and thus the SeNB 200 may be added.

FIG. 12A and FIG. 12B are a flowchart illustrating the method C1 of changing an SeNB in the Alt.Arch.1 in accordance with an exemplary embodiment of the present invention.

Referring to FIG. 12A and FIG. 12B, communication is performed through a radio bearer configured through the radio resources of the SeNB 200 and a radio bearer configured through the radio resources of the MeNB 100 (a dual connectivity-based communication step) at step S1201.

Thereafter, the UE 300 sends a measurement report to the MeNB 100 (a measurement report step) at step S1202. The MeNB 100 determines whether or not to change the SeNB 200 by taking into consideration information about the channel of the SeNB 200 that has been measured and reported by the UE 300 (an SeNB change determination step) at step S1203.

Furthermore, the MeNB 100 requests SeNB setup from a new SeNB (i.e., a target SeNB, SeNB#2) 210. The new SeNB 210 performs admission control and then sends SeNB setup ACK to the MeNB 100 (a new SeNB setup request step) at step S1204.

In response to the SeNB setup ACK from the new SeNB 210, the MeNB 100 buffers the downlink data of a corresponding radio bearer. If a bearer split is possible, the MeNB 100 may perform a procedure of changing a downlink radio bearer configured in the MeNB 100, and may then perform service using the corresponding radio bearer (a downlink data buffering step) at step S1205.

Thereafter, the MeNB 100 transfers an SeNB addition message for the new SeNB 210 to the UE 300. In this case, cause information included in the SeNB addition message is a change of an SeNB (a new SeNB addition step) at step S1206.

In response to the SeNB addition message for changing the SeNB to the new SeNB 210, the UE 300 buffers the uplink data of a corresponding radio bearer (an uplink data buffering step) at step S1207. If a bearer split is possible, the UE 300 may perform a procedure of changing the uplink radio bearer configured in the MeNB 100, and may then perform service using a corresponding radio bearer.

Thereafter, the UE 300 performs uplink synchronization with the new SeNB 210 (an uplink synchronization step) at step S1208. Furthermore, the UE 300 that has obtained the uplink synchronization with the new SeNB 210 transfers an SeNB addition ACK message to the MeNB 100 (an SeNB addition ACK step) at step S1209. In response to the SeNB addition ACK message from the UE 300, the MeNB 100 transfers an SeNB addition indication message to the new SeNB 210 (an SeNB addition indication step) at step S1210. That is, the “uplink synchronization step”, “SeNB addition ACK step”, and “SeNB addition indication step” of the SeNB change procedure are the same as those of the SeNB addition procedure of FIG. 10A and FIG. 10B are.

Thereafter, in response to the SeNB addition ACK message from the UE 300, the MeNB 100 transfers a packet transfer message that requests the transfer of transmitted and received packets to the existing SeNB (i.e., the Source SeNB, SeNB#1) 200. In response to the packet transfer message from the MeNB 100, the existing SeNB transfers the buffered downlink packets to the new SeNB 210 (a traffic transfer step) at step S1211.

Thereafter, the UE 300, together with the new SeNB 210, configures radio resources (a radio resource configuration step for SeNB addition) at step S1212. Such a step may be performed simultaneously with the “traffic transfer step”. Furthermore, the new SeNB 210 transfers an SeNB setup complete message to the MeNB 100 (an SeNB setup complete step) at step S1213. The “radio resource configuration step for SeNB addition” and the “SeNB setup complete step” illustrated in FIG. 12A and FIG. 12B are the same as those of the SeNB addition procedure illustrated in FIG. 10A and FIG. 10B.

Thereafter, after completing a procedure for configuring the radio resources of the new SeNB 210, the MeNB 100 requests the existing SeNB to perform a procedure for releasing its radio resources. In response to the request, the existing SeNB releases its radio resources (an SeNB release step) at step S1214. Furthermore, the MeNB 100 updates RRC context by changing information about the dually connected SeNB to information regarding the new SeNB 210 (an RRC context update step) at step S1215.

Thereafter, the UE 300 may perform dual connectivity-based communication with the MeNB 100 and the new SeNB 210 (a dual connectivity-based communication step) at step S1216.

In accordance with the method 2, the MeNB 100 relays the RRC connection reconfiguration message of the new SeNB 210 to the UE 300 in order to change the existing SeNB. In response to the RRC connection reconfiguration message, the UE 300 performs uplink/downlink synchronization with the new SeNB 210 and then sends an RRC connection reconfiguration complete message to the new SeNB 210. Accordingly, the existing SeNB may be changed. The “method 2” is different from the “method C1” in that the RRC messages for changing an SeNB are exchanged with the UE 300 through the MeNB 100 and the SeNB.

FIG. 13 is a flowchart illustrating the SeNB change method C2 of the Alt.Arch.1 in accordance with another exemplary embodiment of the present invention.

Referring to FIG. 13, in the SeNB change method of the Alt.Arch.1, as in the SeNB change method of FIG. 12A and FIG. 12B, dual connectivity-based communication is performed through a first MeNB 100 and an existing SeNB at step S1301. Thereafter, a measurement report step S1302, an SeNB change determination step S1303, and a new SeNB setup request step S1304 may be performed in the same manner as the “method C1” of FIG. 12A and FIG. 12B is performed. In this case, cause information included in an SeNB setup message is a change of the existing SeNB.

Thereafter, in response to an SeNB setup ACK message from the SeNB, the MeNB 100 buffers uplink/downlink data in order to change the existing SeNB. Furthermore, the MeNB 100 extracts an RRC connection reconfiguration message from the SeNB setup ACK message, and transfers the RRC connection reconfiguration message to the UE 300. In this case, cause information included in the RRC connection reconfiguration message is a change of the existing SeNB. When an setup ACK message is received from the new SeNB 210, the MeNB 100 buffers the data of a corresponding radio bearer. When an RRC connection reconfiguration message is received from the MeNB 100, the UE 300 buffers the data of a corresponding radio bearer. If a bearer split is possible, a procedure of changing a radio bearer configured in the MeNB 100 may be performed, and then service may be provided through a changed radio bearer. Thereafter, the UE 300 performs uplink synchronization along with the new SeNB 210, configures radio resources, and then transfers an RRC connection reconfiguration complete message to the new SeNB 210 (a radio resource configuration step for an SeNB change) at step S1305.

The new SeNB 210 completes an RRC connection reconfiguration along with the UE 300, and transfers an SeNB setup complete message to the MeNB 100 (an SeNB setup complete step) at step S1306.

Thereafter, in response to an SeNB addition ACK message from the UE 300, the MeNB 100 transfers a packet transfer message that requests the transfer of transmitted/received packets to the existing SeNB (i.e., the Source SeNB, SeNB#1). In response to the packet transfer message from the MeNB 100, the existing SeNB transfers the buffered downlink packets to the new SeNB 210 (a traffic transfer step) at step S1307. The “traffic transfer step” is the same as that of the SeNB change procedure of FIG. 12A and FIG. 12B according to the method C1.

Thereafter, the MeNB 100 releases radio resources configured in the existing SeNB along with the existing SeNB (an SeNB release step) at step S1308, and updates the RRC context of the new SeNB 210 (an RRC context update step) at step S1309. Furthermore, the UE 300 may perform dual connectivity-based communication with the MeNB 100 and the new SeNB 210 (a dual connectivity-based communication step) at step S1310. That is, the “SeNB release step”, the “RRC context update step”, and the “dual connectivity-based communication step” according to the method C2 are the same as those of the SeNB change procedure according to the method C1 illustrated in FIG. 12A and FIG. 12B.

A method of reconfiguring an SeNB in accordance with an exemplary embodiment of the present invention is described below.

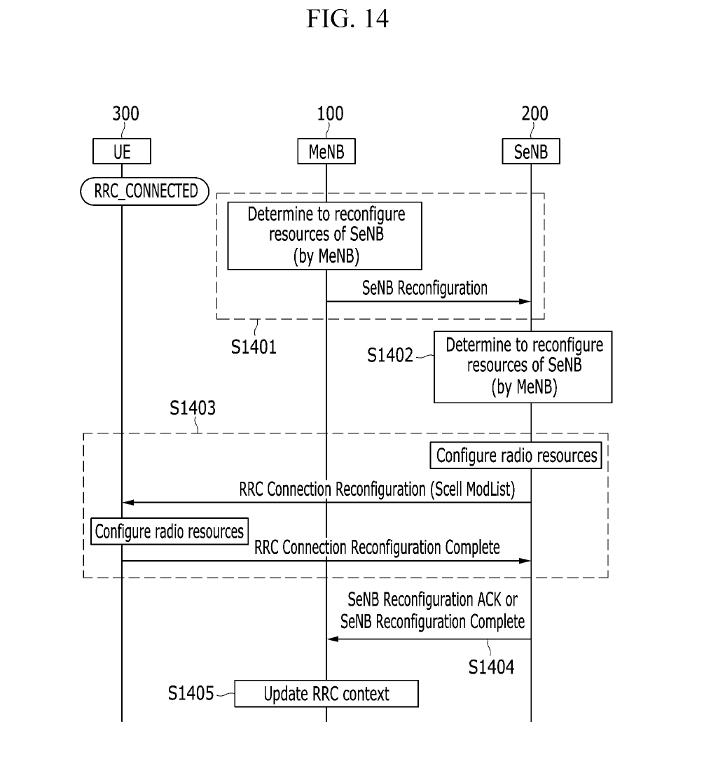

FIG. 14 is a flowchart illustrating a method of reconfiguring an SeNB in the Alt.Arch.1 in accordance with an exemplary embodiment of the present invention.

In the present invention, the method of reconfiguring an SeNB is for changing the configuration of the radio resources of the SeNB 200 under the control of the MeNB 100 or in response to a request from the SeNB 200.

Referring to FIG. 14, first, the MeNB 100 determines whether or not to change information about the configuration of the radio resources of the SeNB 200 by taking into consideration information about the channel of the SeNB 200 that has been measured and reported by the UE 300. Furthermore, the MeNB 100 transfers an SeNB reconfiguration message, including a parameter for reconfiguring the radio bearer of an SeNB and a radio bearer identifier, to the SeNB 200 (an SeNB reconfiguration request step) at step S1401.

In response to the SeNB reconfiguration message from the MeNB 100, the SeNB 200 determines whether or not to accept the SeNB reconfiguration request through the Radio Bearer Control (RBC) function of the RRM.

Meanwhile, if the SeNB 200 autonomously configures information about the configuration of the radio resources of the SeNB 200, the step of requesting an SeNB reconfiguration may not be performed. The SeNB 200 may determine whether or not to change the information about the configuration of the radio resources of the SeNB 200 in response to a request from an under 2-layer protocol of the SeNB 200 (an SeNB reconfiguration determination step) at step S1402. Such a step is not performed when the SeNB reconfiguration procedure is performed by the MeNB 100 (an SeNB reconfiguration request step). That is, the SeNB reconfiguration request step and the SeNB reconfiguration determination step may be selectively performed.

If the SeNB 200 accepts the SeNB reconfiguration request of the MeNB 100 or determines to reconfigure an SeNB, the SeNB 200 changes the configuration of the radio resources (a radio resource configuration) and sends an RRC connection reconfiguration message for reconfiguring an SeNB to the UE 300. Furthermore, in response to the RRC connection reconfiguration message from the SeNB 200, the UE 300 changes the configuration of the radio resources and sends an RRC connection reconfiguration complete message to the SeNB 200 (an SeNB reconfiguration step) at step S1403.

After reconfiguring the configuration of the radio resources of the SeNB 200, the SeNB 200 sends an SeNB reconfiguration ACK message to the MeNB 100 that has requested the reconfiguration of the SeNB. In this case, if the reconfiguration of the SeNB 200 has been requested by the MeNB 100, the SeNB 200 sends the SeNB reconfiguration ACK message to the MeNB 100. If the SeNB 200 has determined the reconfiguration of the SeNB, the SeNB 200 sends an SeNB reconfiguration complete message to the MeNB 100 (an SeNB reconfiguration ACK step) at step S1404.

Thereafter, the MeNB 100 updates RRC context including the attributes of a corresponding radio bearer (an RRC context update step) at step S1405.

A method of releasing the SeNB 200 in accordance with an exemplary embodiment of the present invention is described below.

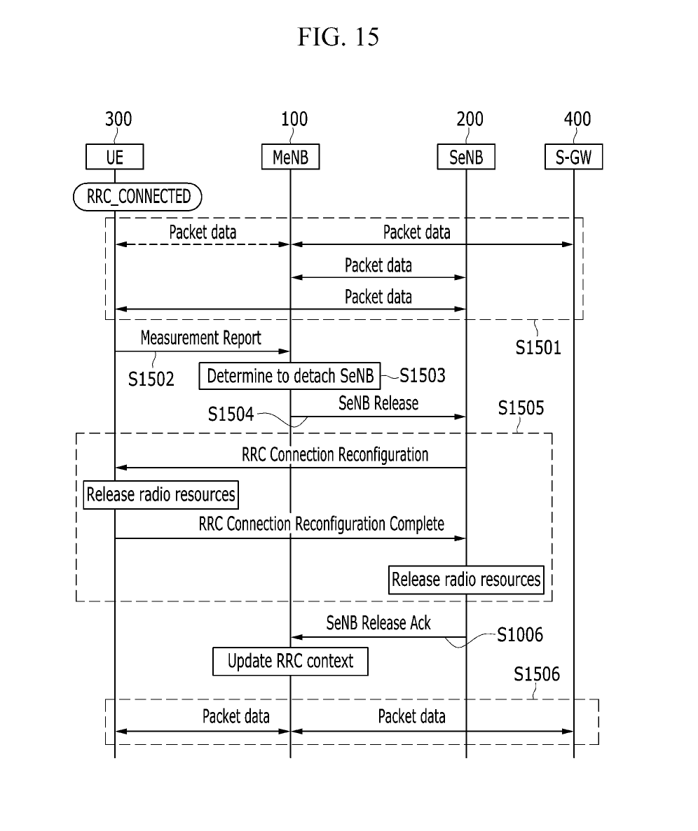

FIG. 15 is a flowchart illustrating a method of releasing an SeNB in the Alt.Arch.1 in accordance with an exemplary embodiment of the present invention.

In the SeNB release procedure, the connection of the SeNB 200 with the UE is released under the control of the MeNB 100 or in response to a request from the SeNB 200 UE.

Referring to FIG. 15, first, the UE 300 performs communication using a radio bearer configured through the radio resources of the SeNB 200 and a radio bearer configured through the radio resources of the MeNB 100 (a dual connectivity-based communication step) at step S1501. The UE 300 periodically performs measurement based on the setting of the MeNB 100. If conditions set by the MeNB 100 are satisfied, the UE 300 reports a result of the measurement to the MeNB 100. The MeNB 100 receives the measurement report from the UE 300 (a measurement report step) at step S1502. That is, such a step is the same as the measurement report step of the SeNB addition procedure.

Thereafter, the MeNB 100 determines whether or not to release the SeNB 200 by taking into consideration information about the channel of the SeNB 200 that has been measured and reported by the UE 300 (an SeNB release determination step) at step S1503. Furthermore, the MeNB 100 requests SeNB release from the SeNB 200 based on the information about the channel of the SeNB 200 measured by the UE 300 (an SeNB release request step) at step S1504. For such a procedure, the MeNB 100 may transfer an SeNB release request message, including information about the C-RNTI of the UE 300 that provides dual connectivity, to the SeNB 200.

In response to the SeNB release request message from the MeNB 100, the SeNB 200 performs an SeNB release procedure.

In order to release the SeNB, the SeNB 200 sends an RRC connection reconfiguration message to the UE 300. In response to the RRC connection reconfiguration message, the UE 300 releases radio resources configured therein and then transfers an RRC connection reconfiguration complete message to the SeNB 200. In response to an RRC connection release ACK message, the SeNB 200 releases the configured radio resources (a radio resource release step for SeNB release) at step S1505. Such a procedure may be performed in response to the SeNB release request message received from the MeNB 100 if the SeNB release procedure is started from the MeNB 100, and may be performed in response to a determination of the RRM function of the SeNB 200 if the SeNB release procedure is started from the SeNB 200.

After completing the procedure of releasing the radio resources of the SeNB 200, the SeNB 200 transfers an SeNB release ACK message to the MeNB 100 (an SeNB release ACK step) at step S1506.

Furthermore, in response to the SeNB release ACK message from the SeNB 200, the MeNB 100 changes the RRC context of the UE 300 to the single connectivity state (an RRC context update step) at step S1507.

Thereafter, the UE 300 performs a communication procedure along with the MeNB 100 through a configured radio bearer (a single connectivity-based communication step) at step S1508.

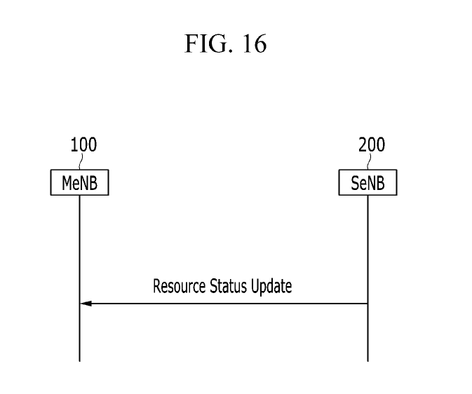

FIG. 16 is a flowchart illustrating a method of reporting an SeNB buffer state in the Alt.Arch.1 in accordance with an exemplary embodiment of the present invention.

In the present invention, an SeNB buffer state report means that the state of the PDCP transfer buffer of the SeNB 200 is reported to the MeNB 100.

Referring to FIG. 16, the SeNB 200 may transfer a resource status update message to the MeNB 100 according to conditions set under the control of the RRC. The resource status update message includes indicating the status of the downlink transfer buffer, and conditions in which the resource status update message is transferred may be defined by the RRC periodically or when a specific event occurs.

Pieces of information exchanged between the MeNB 100, the SeNB 200, and the UE 300 in order to provide dual connectivity through the Alt.Arch.1 and a method of exchanging the pieces of information are described below.

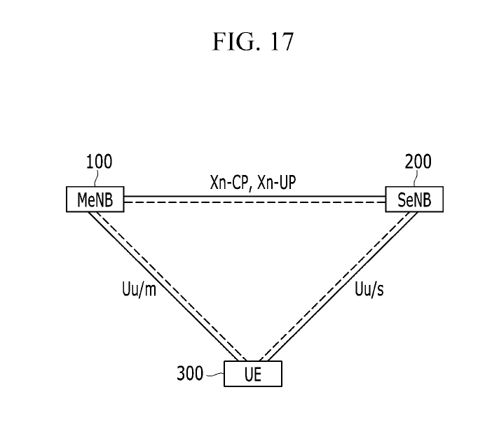

FIG. 17 is a diagram illustrating the connection state of the MeNB, the SeNB, and the UE in the Alt.Arch.1 in accordance with an exemplary embodiment of the present invention.

Referring to FIG. 17, a reference point between the MeNB 100 and the SeNB 200 is defined as “Xn”, and pieces of information of the control plane and pieces of information of the user plane exchanged at the reference point are defined as Xn-CP (control plane) exchange information and Xn-UP (user plane) exchange information, respectively. Furthermore, a reference point between the MeNB 100 and the UE 300 is defined as “Uu/m”, and a reference point between the SeNB 200 and the UE 300 is defined as “Uu/s”.

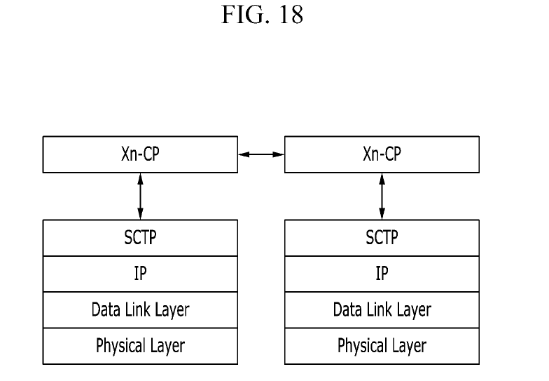

FIG. 18 is a diagram illustrating the interoperation structure of the control plane in accordance with an exemplary embodiment of the present invention.

Referring to FIG. 18, Xn-CP, a control plane interface between the MeNB 100 and the SeNB 200 for providing dual connectivity may provide the following functions.
*SeNB management function
SeNB setup, SeNB change, and SeNB release
SeNB reconfiguration
SeNB buffer status report
Flow control between an MeNB and an SeNB: if downlink traffic is controlled through a control plane protocol (such flow control is performed when the method D1 is used)
*Xn-UP management
A traffic bearer management function (configuration, change, and release) between an MeNB and an SeNB
*RLF reporting from an SeNB to an MeNB

Furthermore, referring to FIG. 18, like X2-CP, Xn-CP is a signaling protocol of an application level that operates based on a Stream Control Transmission Protocol/Internet Protocol (SCTP/IP)-based transport network.

“Uu/m”, that is, the control plane interface between the MeNB 100 and the UE 300 for providing dual connectivity, and “Uu/s”, that is, the control plane interface between the SeNB 200 and the UE 300 for providing dual connectivity, provide the following functions.
*RRC function for dual connectivity
SeNB request and response
RRC connection reconfiguration

SeNB setup, SeNB change, and SeNB release

SeNB reconfiguration
Measurement configuration and reporting

Object for SeNB management

Table 4 defines messages exchanged through Xn-CP and Uu if dual connectivity is provided through the Alt.Arch.1.

TABLE 4

| Protocol | | | | |
|---|---|---|---|---|
| message | Description | RP | IE | Remark |
| SeNB Setup | SeNB setup request | Xn-CP | Setup type | Method A1 |
| | message | | Bearer attributes | Method C1 |
| | | | C-RNTI | |
| | | | Setup type | Method A2 |
| | | | Bearer attributes | Method C2 |
| | | | C-RNTI | |
| | | | Xn-U info. | |
| | | | Security Key | |
| SeNB Setup | SeNB setup ACK message | Xn-CP | Result code | Method A1 |
| ACK | | | | Method C1 |
| | | | Result code | Method A2 |
| | | | RRC message | Method C2 |
| SeNB Setup | SeNB setup complete | Xn-CP | | |
| Complete | message | | | |
| SeNB addition | SeNB addition request | Uu/m | Cause | Method A1 |
| | message | | | Method C1 |
| SeNB addition | SeNB addition ACK | Uu/m | Result code | Method A1 |
| ACK | message | | | Method C1 |
| SeNB addition | SeNB addition | Xn-CP | Xn-U info. | Method A1 |
| Ind | confirmation message | | Security Key | Method C1 |
| RRC Connection | | Uu/m | SeNB Addition | Method A1 |
| Reconfiguration | | | List | Method C1 |
| | | | Cause | |
| | | Uu/s | SeNB Addition | Method A2 |
| | | | List | Method C2 |
| RRC | | Uu/m | | Method A1 |
| Connection | | | | Method C1 |
| Reconfiguration | | | | |
| Complete | | | | |
| | | Uu/s | | Method A2 |
| | | | | Method C2 |
| Packet Transfer | Transfer request message | Xn-CP | | |
| | of buffered packets | | | |
| Packet Transfer | Packet transfer ACK | Xn-CP | | |
| ACK | message | | | |
| SeNB Release | SeNB release request | Xn-CP | | |
| | message | | | |
| SeNB Release | SeNB release ACK | Xn-CP | | |
| ACK | message | | | |
| SeNB | SeNB reconfiguration | Xn-CP | RB id. | |
| reconfiguration | request message | | SeNB | |
| | | | Modification List | |
| SeNB | SeNB reconfiguration | Xn-CP | Result Code | |
| reconfiguration | ACK message | | | |
| ACK | | | | |
| Resource Status | Downlink buffer | Xn-CP | DL Buffer Status | |
| Update | information report | | | |
| | message of SeNB | | | |

Table 5 defines information entities included in messages exchanged through Xn-CP of Table 4.

TABLE 5

| Information | | |
|---|---|---|
| Element | Descriptions | Remarks |
| Setup Type | SeNB setup type | — |
| | Initial setup/SeNB change | |
| Bearer | Attributes of radio bearer | |
| Attributes | | |
| Security Key | K_{enb}* | |
| C-RNTI | Cell-Radio Network Temporary | |
| | Identifier | |
| Xn-U info. | Information for configuring Xn-U | |
| Result Code | Result code | |
| | Success/failure | |
| RRC message | RRC connection reconfiguration | Included |
| | message | in SeNB |
| | | setup ACK |
| SeNB Addition | Information configured when SeNB | |
| List | is set up | |
| SeNB | Information configured when SeNB | |
| Modification | is modified | |
| List | | |
| RB id. | Radio Bearer Identifier | |
| DL Buffer | Status of downlink buffer | |
| Status | Low/medium/high/overload | |

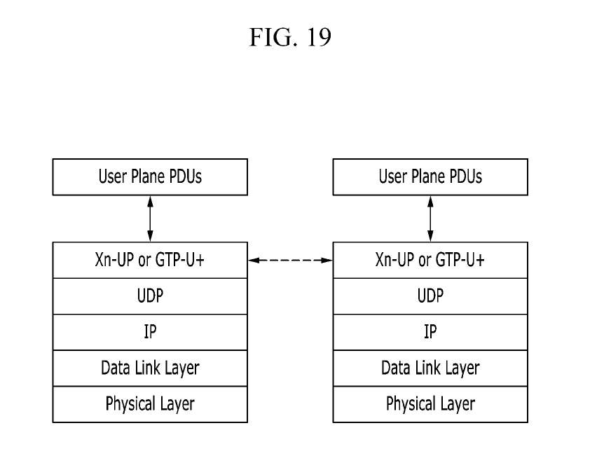

FIG. 19 is a diagram illustrating the interoperation structure of a user plane in accordance with an exemplary embodiment of the present invention.

Referring to FIG. 19, Xn-UP, that is, the user plane interface between the MeNB 100 and the SeNB 200 for providing dual connectivity, may provide the following functions.
*Transfer of traffic between an MeNB and an SeNB
Flow control between an MeNB and an SeNB: if downlink traffic is controlled through a user plane protocol (such flow control is performed when the method D2 is used)

As in the structure of X2-UP, Xn-UP may operate based on a GPRS Tunneling Protocol/User Datagram Protocol (GTP-U/UDP)-based transport network.

In the present invention, UuUP/m, that is, a user plane interface between the MeNB 100 and the UE 300 for providing dual connectivity, may provide the following functions.
*BM PDU management
PDCP PCU ordering and in-sequence delivery

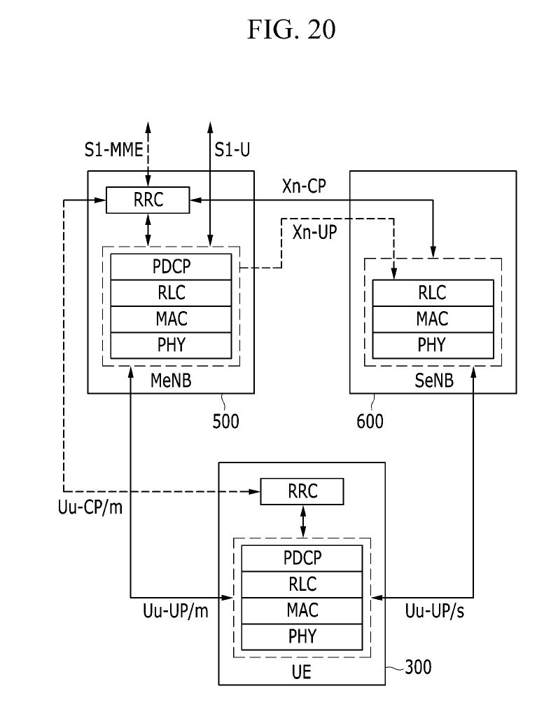

FIG. 20 is a diagram illustrating a wireless communication system for providing dual connectivity in accordance with another exemplary embodiment of the present invention.

FIG. 20 illustrates the Alt.Arch.2 of the wireless communication system for providing dual connectivity.

Referring to FIG. 20, the MeNB 500 of the Alt.Arch.2 is connected to an MME and an S-GW through an S1-MME, that is, a control plane interface, and an S1-U, that is, a user plane interface, respectively. Furthermore, each of the MeNB 500 and the UE 300 of the Alt.Arch.2 includes an RRC protocol, a PDCP, an RLC protocol, a MAC protocol, and a PHY protocol as in the Alt.Arch.1 of FIG. 1, but an SeNB 600 does not include an RRC protocol and a PDCP. That is, in terms of a user plane protocol, the MeNB 500 includes all the 2-layer protocols, whereas the SeNB 600 includes 2-layer protocols other than the PDCD.

In the Alt.Arch.2 in accordance with an exemplary embodiment of the present invention, each of the MeNB 500 and the SeNB 600 may provide a CA function using a plurality of CCs. Accordingly, the eNB (the MeNB 500 or the SeNB 600) manages a primary cell and a secondary cell. In this case, a group of cells managed by the MeNB 500 is called a Master Cell Group (MCG), and a group of cells managed by the SeNB 600 is called a Secondary Cell Group (SCG).

The functions and structures of the RRC and RRM for performing the control plane functions of the Alt.Arch.2 are described below.

In the Alt.Arch.2 in accordance with an exemplary embodiment of the present invention, the functions of an RRC protocol are performed by the MeNB 500. In the Alt.Arch.2, the SeNB 600 may operate under the control of the RRC of the MeNB 500.

That is, in the RRC_CONNECTED state of Table 2, all the RRC functions are placed in the MeNB 500. The execution of the 2-layer protocols and the configuration of the physical layer according to an RRC operation may be performed through an Xn interface between the MeNB 500 and the SeNB 600.

First, a system information broadcast function of the RRC functions described in Table 2 is described. The MeNB 500 transfers the system information of the SeNB 600, related to an AS that may be taken into consideration in the Alt.Arch.2, to the UE 300 in the dual connectivity state using a dedicated bearer-based RRC message. That is, the MeNB 500 may determine whether or not the system information has been changed while operating in conjunction with the SeNB 600. If the system information of the SeNB 600 has been changed, the MeNB 500 may transfer the changed system information to the UE 300 through a dedicated radio bearer. In greater details, UE 300 receives Master Information Block (MIB) from SeNB 600 and System Information Block (SIB) from MeNB 500 through the dedicated radio bearer to recognizing System Frame Number (SFN) and Sub-frame Number (SN) of MeNB 500 and SeNB 600. Additionally, UE 300 may report differences between the SFNs of the MeNB 500 and the SeNB 600 to the MeNB 500 and the differences between the SFNs may be used to configure the DRX and measurement of MeNB 500.

Furthermore, in the Alt.Arch.2 in accordance with an exemplary embodiment of the present invention, the RRC connection management functions of the RRC functions, that is, RRC connection establishment/modification/release functions, may be controlled by the MeNB 500.

Furthermore, in the Alt.Arch.2, the exchange of pieces of key information K_{eNB}, K_{RRCint}, K_{RRCenc}, and K_{UPenc} for the operation of the PDCP between the MeNB 500 and the SeNB 600 is not required because the PDCP responsible for the integrity protection/encryption function of an SRB and DRB is present only in the MeNB 500. Accordingly, an initial security activation procedure may be performed while SecurityModeCommand messages and SecurityModeComplete messages are exchanged between the MeNB 500 and the UE 300.

In the Alt.Arch.2, RRC connection mobility is controlled by the MeNB 500 by taking mobile robustness into consideration.

Furthermore, the management of DRBs, that is, the establishment/modification/release of the DRBs, may be implemented when the MeNB 500 performs an RRC procedure on DRBs configured in the MeNB 500 and the SeNB 600. In order to manage DRBs, the MeNB 500 and the SeNB 600 may exchange parameters for a DRB configuration and perform an RRC operation procedure for controlling the DRBs based on the exchanged parameters.

Furthermore, in the Alt.Arch.2, control of a radio configuration is performed by the MeNB 500, and a configuration according to control of the MeNB 500 is performed by the MeNB 500 or the SeNB 600. That is, the MeNB 500 performs a radio resource configuration procedure for managing the radio bearers of the RRC. Furthermore, the operation parameters of the 2-layer protocols and physical layer placed in the SeNB 600 are set according to the radio resource configuration procedure of the MeNB 500.

In the Alt.Arch.2, control of QoS includes the configuration of SPS and the uplink rate control function of the UE 300. Control of the corresponding functions are performed by the MeNB 500.

Furthermore, in the Alt.Arch.2, the UE 300 sets parameters for detecting an RLF using system information and configuration information provided by the MeNB 500, and works together with the MeNB 500 when the RLF occurs. That is, when the RLF occurs at wireless link between the UE 300 and the MeNB 500, the UE 300 may perform an RLF recovery procedure through an RRC connection re-establishment procedure while operating in conjunction with the MeNB 500. And, if an error occurs in a radio link, the RLC, MAC, and PHY of the SeNB 600 report information about the error to the RRC placed in the MeNB 500. The MeNB 500 may control the RLF of the SeNB 600 based on the report. In this case, UE 300 should detect the RLF of SeNB 600 and define RRC message that may report the incidence of the RLF to the MeNB 500. In the Alt.Arch.2 in accordance with an exemplary embodiment of the present invention, the RRC message may be defined as Secondary RLF(S-RLF) Indication message.

In the Alt.Arch.2, the measurement configuration and report procedure of the UE 300 may be controlled by the MeNB 500.

In addition, information about a dedicated NAS, information dedicated to non-3GPP, and information about the capabilities of the UE 300 for sharing an E-UTRAN may be performed by the MeNB 500 because they correspond to an information exchange procedure for an operational procedure between the MME and the UE 300.

Table 6 defines RRM functions other than functions related to Inter-RAT in the control plane of the Alt.Arch.2.

TABLE 6

| | Main functions | MeNB | SeNB |
|---|---|---|---|
| Radio Bearer | Establishment, maintenance, and | X | X |
| Control | release of radio bearers | | |
| Radio | Admission or rejection of | X | X |
| Admission | establishment requests for new radio | | |
| Control | bearers | | |
| Connection | Management of radio resources in | X | |
| Mobility | connection with idle and connected | | |
| Control | mode mobility | | |
| Dynamic | Allocation and de-allocation of | X | X |
| Resource | resources to user and control plane | | |
| Allocation | packets | | |
| Inter-cell | Management of radio resources such | X | X |
| Interference | that inter-cell interference is kept | | |
| Coordination | under control | | |
| Load | Handling of uneven distribution of | X | |
| Balancing | the traffic load over multiple cells | | |

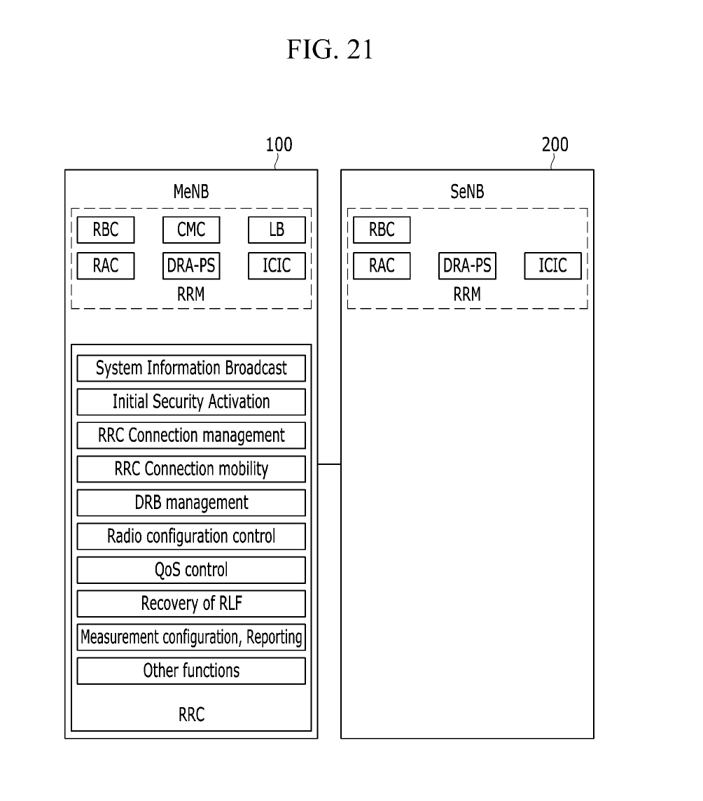

Furthermore, FIG. 21 is a diagram illustrating the functions and structures of the RRC and RRM in the control plane of the Alt.Arch.2 for providing dual connectivity.

Referring to FIG. 21, functions corresponding to the RRC are not illustrated because an RRC protocol is not executed in the SeNB 600, and the RRM functions are limitedly illustrated. Unlike in the RRM of the MeNB 500, a Connection Mobility Control (CMC) function, and a Load Balancing (LB) function are excluded from the RRM of the SeNB 600.

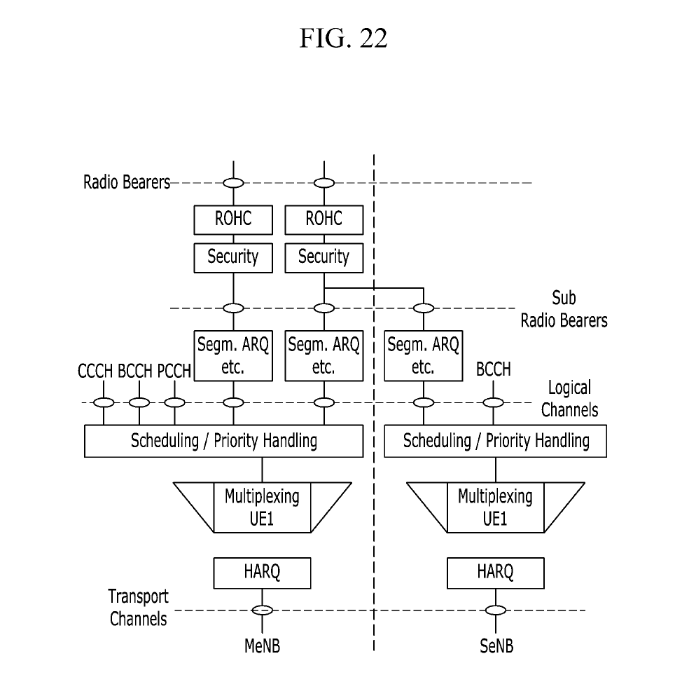

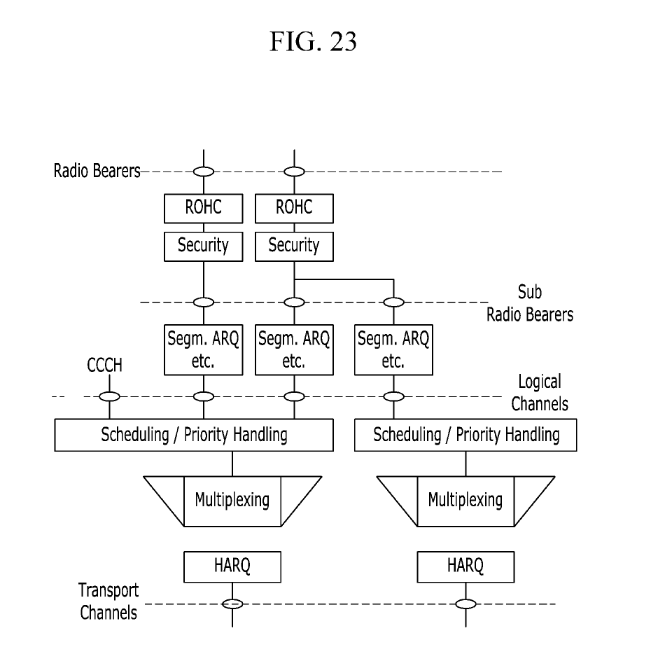

FIG. 22 is a diagram illustrating a protocol stack of user plane downlink in the wireless communication system for providing dual connectivity in accordance with another exemplary embodiment of the present invention, and FIG. 23 is a diagram illustrating a protocol stack of user plane uplink in the wireless communication system for providing dual connectivity in accordance with another exemplary embodiment of the present invention.

In the user plane of the Alt.Arch.2, in order to provide dual connectivity, a concept of a sub-radio bearer including a Master Radio Bearer (M-RB) and a Secondary Radio Bearer (S-RB) may be newly defined. That is, in the Alt.Arch.2, in order to provide dual connectivity, a single radio bearer may be split into an M-RB configured in the MeNB 500 and an S-RB configured in the SeNB 600. The M-RB and the S-RB may be placed at a Service Access Point (SAP) between the PDCP and the RLC.

Furthermore, in order to transfer user traffic between the MeNB 500 and the SeNB 600, the PDCP of the Alt.Arch.2 requires a function capable of splitting the user traffic under the control of the control plane in a PDCP PDU step. Accordingly, the following functions may be additionally introduced into the PDCP of the Alt.Arch.2.

The PDCP of the Alt.Arch.2 may perform routing and flow control functions between the MeNB 500 and the SeNB 600. First, the PDCP may route uplink/downlink packets based on flow control configuration information. The PDCP of the MeNB 500 may transfer a downlink PDCP PDU to a sub-radio bearer of the MeNB 500 or the SeNB 600, and the PDCP of the UE 300 may transfer an uplink PDCP PDU to a configured sub-radio bearer (the MeNB 500 or the SeNB 600).

Furthermore, the PDCP may generate and exchange management messages for flow control. Such a function is performed by flow control using a user plane protocol. A PDCP management message for flow control between the MeNB 500 and the SeNB 600 is defined. Such flow control may be performed through the exchange of the PDCP management messages.

Furthermore, the PDCP may perform the rearrangement and in-sequence delivery of traffic in the case of a bearer split. If a single EPS bearer is split into a plurality of radio bearers, the plurality of radio bearers may be rearranged and transferred in sequence using the sequence number of the PDCP. To this end, if an abnormal backhaul between the MeNB 500 and the SeNB 600 is taken into consideration, the PDCP SN of a longer length (12+x) may need to be used by extending the length of the SN proposed by the existing Rel-11 PDCP. In this case, the format of the PDCP PDU may be changed.

Finally, the PDCP may perform PDU buffering in response to a change of the SeNB 600. The PDCP of the MeNB 500 may buffer downlink PDCP PDUs, and the PDCP of the UE 300 may buffer uplink PDCP PDUs.

As in the Alt.Arch.1, in the Alt.Arch.2, the MeNB 500 and the SeNB 600 include independent MAC functions. Accordingly, characteristics related to the MAC when the Alt.Arch.2 provides dual connectivity are the same as those of the Alt.Arch.1 other than the channel mapping structure of the SeNB 600 and a data structure for the BSR.

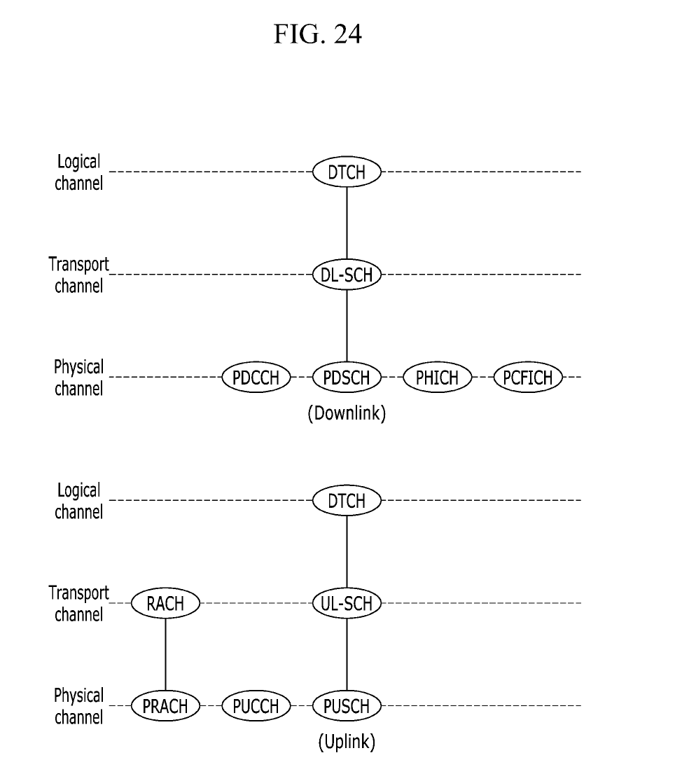

FIG. 24 is a diagram illustrating the uplink/downlink channel mapping configuration of the SeNB in accordance with another exemplary embodiment of the present invention.

Referring to FIG. 24, the channel mapping configuration of the SeNB 600 in accordance with the current exemplary embodiment of the present invention supports dedicated traffic channels in downlink and supports dedicated traffic channels and random access channels in uplink.

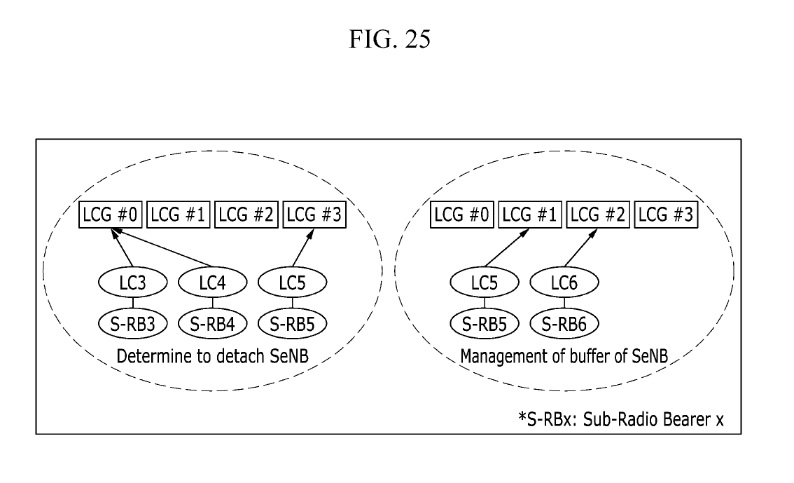

FIG. 25 is a diagram illustrating the buffer management structure of the UE in accordance with another exemplary embodiment of the present invention.

In the Alt.Arch.2, a procedure for allocating uplink radio resources to the UE 300 is the same as that of the MAC layer of the Alt.Arch.1 other than the data structure for the BSR. In the Alt.Arch.2, for the BSR procedure, the UE 300 manages an LCG based on sub-radio bearers (M-RB or S-RB) and logical channels configured in each of the MeNB 500 and the SeNB 600, and performs a BSR (e.g., a short BSR, long BSR, or truncated BSR) procedure along with the MeNB 500 or the SeNB 600 using the LCG.

In the Alt.Arch.2, downlink data traffic for providing dual connectivity may be controlled in accordance with the following method.

The downlink data traffic (e.g., a PDCP PDU) of the Alt.Arch.2 in accordance with the current exemplary embodiment of the present invention may be transferred to the UE 300 using the downlink radio resources of the MeNB 500 or the SeNB 600 under the control of the RRC/PDCP of the MeNB 500. Furthermore, the uplink PDCP PDU of the Alt.Arch.2 may be transferred to the MeNB 500 or the SeNB 600 using uplink radio resources under the control of the RRC/PDCP of the UE 300.

In the Alt.Arch.2, in order to efficiently provide dual connectivity, data needs to be transferred according to flow control between the MeNB 500 and the SeNB 600 as in the flow control of the Alt.Arch.1.

In the Alt.Arch.2, in order to solve a downlink traffic flow control problem, the MeNB 500 and the SeNB 600 may perform flow control for the transfer of the traffic of the MeNB 500 and the SeNB 600 using the following method and procedure (this is similar to the flow control method of the Alt.Arch.1). Control of a downlink traffic flow may be performed when data is transferred using the SeNB 600 regardless of a bearer split.
A downlink flow control method D1: using a control plane protocol

In such a method, the RRC of the MeNB 500 performs flow control for the transfer of traffic between the MeNB 500 and the SeNB 600. In accordance with this method, the RRC of the MeNB 500 may set the flow control-initial value of a radio bearer in the PDCP when configuring the corresponding radio bearer. The RRC of the MeNB 500 may dynamically perform flow control by controlling the PDCP based on a report on the downlink buffer state of the SeNB 600 while service is provided. If such a method is used, a protocol procedure related to flow control between the MeNB 500 and the SeNB 600 may be performed through the Xn-CP.
A downlink flow control method D2: using a user plane protocol

In such a method, the PDCP of the MeNB 500 performs flow control for the transfer of traffic between the MeNB 500 and the SeNB 600. In accordance with this method, the RRC of the MeNB 500 may set a flow control-initial value for a radio bearer in the PDCP of the MeNB 500 when configuring the corresponding radio bearer. The PDCP of the MeNB 500 may dynamically perform flow control on a PDCP PDU based on a downlink buffer state that is reported by the SeNB 600 while service is provided. If such a method is used, a protocol procedure related to flow control between the MeNB 500 and the SeNB 600 may be performed through the Xn-UP.

A method of performing, by the MeNB 500 and the SeNB 600, flow control for the transfer of the traffic using the “downlink flow control method D1” is described below.

First, when configuring a radio bearer (including an M-RB and an S-RB) for dual connectivity, the RRC of the MeNB 500 sets an initial value for the flow control of a downlink packet, transferred to the MeNB 500 and the SeNB 600, in the PDCP (a PDCP-initial setting step). The initial value may be set by taking into consideration the QoS characteristics of a radio bearer configured in the MeNB 500 and the SeNB 600. Furthermore, the PDCP may process the downlink packet using a packet flow setting value set when a radio bearer is initially configured. Likewise, the parameter fc_{m.d} or fc_{s.d} of the Alt.Arch.1 may be used as a parameter used in the flow control of the PDCP.

After configuring the radio bearer, the RRC of each of the MeNB 500 and the SeNB 600 checks the state of a downlink RLC transfer buffer periodically or when an event is generated (a downlink buffer state report step). In order to perform such a procedure, the RRC may perform a configuration procedure related to a report on the state of the RLC transfer buffer on the RLC when configuring the radio bearer. Furthermore, the configuration related to the report on the state of the RLC transfer buffer may include a periodical report or a report on the occurrence of an event based on the upper threshold value and lower threshold value of the RLC transfer buffer. In this case, the RLC placed in the SeNB 600 reports the state of the downlink RLC transfer buffer, received from the RLC, to the RRC of the MeNB 500 using a protocol message (e.g., a resource status update message) on the Xn-CP in order to report the downlink buffer state.

Furthermore, the RRC that has received the report on the state of the downlink RLC packet buffer of each of the MeNB 500 and the SeNB 600 sets a value for the flow control of the downlink packet, transferred to the MeNB 500 and the SeNB 600, again in response to a change in the downlink buffer state through the reconfiguration procedure of the PDCP (a flow control function reconfiguration step). After the BM reconfiguration procedure of the RRC is performed, the PDCP may process the downlink packet using the newly set packet flow setting value.

A method of performing, by the MeNB 500 and the SeNB 600, flow control for the transfer of the traffic using the aforementioned “downlink flow control method D2” is described below.

First, a step of initially configuring the PDCP when a downlink radio bearer is configured is the same as the first step of the “method D1”.

After the radio bearer is configured, the RLC of each of the MeNB 500 and the SeNB 600 reports the state of the downlink RLC transfer buffer periodically or when an event is generated based on the setting of the RRC (a downlink buffer state report step). To this end, the RLC of the MeNB 500 transfers information about the state of the downlink RLC transfer buffer to the PDCP using local primitives, and the RLC of the SeNB 600 transfers information about the state of the downlink RLC transfer buffer to the PDCP of the MeNB 500 using the Xn-UP.

Thereafter, the PDCP of the MeNB 500 that has received the report on the state of a downlink packet buffer of each of the MeNB 500 and the SeNB 600 dynamically sets a value for the flow control of the downlink packet, transferred to the MeNB 500 and the SeNB 600, again in response to a change of the state of the downlink packet buffer (a flow control function reconfiguration step). The PDCP of the MeNB 500 may process the downlink packet using the newly set packet flow setting value after changing the setting value for the flow control of the downlink packet.

A method for solving a flow control problem in uplink traffic is described below. The UE 300 may perform flow control for the transfer of uplink traffic using the following method. The flow control for the transfer of uplink traffic may be performed when a bearer split occurs, that is, if all the uplink traffic transfer paths of the UE 300 are directed toward the MeNB 500 or the SeNB 600.
An uplink flow control method U1: using a control plane protocol

In such a method, the RRC of the UE 300 performs flow control for the transfer of uplink traffic. In accordance with the method, the RRC of the UE 300 may set the flow control-initial value of a radio bearer in the PDCP when configuring the corresponding radio bearer, and may perform a dynamic flow control procedure by controlling the PDCP based on a report on an uplink buffer state while service is provided.
An uplink flow control method U2: using a user plane protocol

In such a method, the PDCP of the UE 300 performs flow control for the transfer of uplink traffic. In accordance with the method, when the RRC configures a radio bearer, the PDCP of the UE 300 may set the flow control-initial value of the corresponding radio bearer in the BM. While service is provided, the PDCP of the UE 300 may dynamically perform flow control by controlling the PDCP based on a report on an uplink buffer state from the RLC.

A method of performing, by the UE 300, flow control for the transfer of uplink traffic using the “uplink flow control method U1” is described below.

When configuring a radio bearer for dual connectivity, the RRC of the UE 300 sets an initial value for flow control of a packet, transferred to the MeNB 500 and the SeNB 600, in the PDCP (a BM-initial setting step). In this case, a PDCP configuration method for performing such a procedure is the same as the downlink configuration method, and uplink parameters fc_{m.u} and fc_{s.u} may be used in the PDCP configuration method.

After the radio bearer is configured, the RRC of the UE 300 checks the state of the uplink RLC transfer buffer periodically or when an event is generated (an uplink buffer state report step). In this case, an RLC configuration method is the same as the downlink configuration method (i.e., a periodical report or a report when an event is generated).

The RRC that has received a report on the uplink packet buffer state sets the value for flow control of the packet, transmitted in uplink, again through the reconfiguration procedure of the PDCP in response to a change in the uplink packet buffer state (a flow control function reconfiguration step). After the RRC performs the PDCP reconfiguration procedure, the PDCP may process the uplink packet using the newly set packet flow setting value.

A method of performing, by the UE 300, flow control for the transfer of uplink traffic using the aforementioned “uplink flow control method U2” is described below.

First, a step of initially configuring the BM when an uplink radio bearer is configured is the same as the first step of the “method U1”.

After the radio bearer is initially configured, the RLC of the UE 300 reports the state of an uplink RLC transfer buffer to the PDCP periodically or when an event is generated (an uplink buffer state report step).

The PDCP of the UE 300 that has received the report on the state of the uplink packet buffer sets the value for flow control of a packet, transmitted in uplink, again through a reconfiguration procedure in response to a change in the uplink packet buffer state (a flow control function reconfiguration step). After the PDCP performs the reconfiguration procedure, the PDCP of the UE 300 may process the uplink packet using the newly set packet flow setting value.

In the Alt.Arch.2, data between the MeNB 500 and the SeNB 600, that is, a PDCP PDU generated by the PDCP of the MeNB 500, is transferred to the RLC of the MeNB 500 or the RLC of the SeNB 600. Particularly, if the PDCP PDU is transferred through a sub-radio bearer configured in the SeNB 600, the GTP-U+ presented by the user plane interoperation structure of the Alt.Arch.1 may be used as an Xn-UP protocol for a mechanism for transferring data between the MeNB 500 and the SeNB 600.

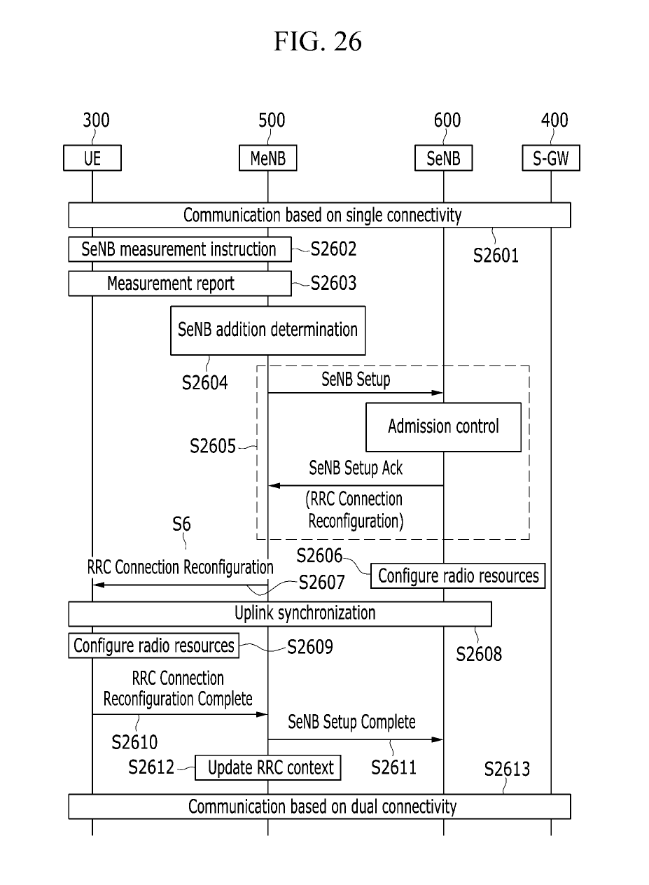

The operational procedure of the wireless communication system for dual connectivity is described below using the control plane and user plane structure of the Alt.Arch.2 with reference to FIGS. 26 to 30. The operational procedure of the Alt.Arch.2 in accordance with another exemplary embodiment of the present invention include an SeNB addition procedure, an SeNB change procedure, an SeNB reconfiguration procedure, an SeNB release procedure, and an SeNB buffer state report procedure.

First, in the Alt.Arch.2, the SeNB addition procedure is described.

FIG. 26 is a flowchart illustrating the SeNB addition procedure in the Alt.Arch.2 in accordance with another exemplary embodiment of the present invention.

Referring to FIG. 26, a “single connectivity-based communication step S2601”, an “SeNB measurement indication step S2602” and a “measurement report step S2603” are the same as those of the SeNB addition method of the Alt.Arch.1 illustrated in FIG. 10A and FIG. 10B.

Thereafter, the MeNB 500 determines whether or not to add the SeNB 600 by taking the load state of the MeNB 500 into consideration (an SeNB addition determination step) at step S2604. In the Alt.Arch.2, an RBC function placed in the MeNB 500 may be used as the radio bearer control of the SeNB 600.

Furthermore, the MeNB 500 requests an SeNB configuration from the SeNB 600 based on the search result of the SeNB performed by the UE 300 and the addition determination of an SeNB performed by the MeNB 500. At this step, the MeNB 500 transfers an SeNB setup message, including at least one of information about the Cell-Radio Network Temporary Identifier (C-RNTI) of the UE 300 for providing dual connectivity, information about the attributes of a radio bearer (SRB or DRB) to be configured, and information about the UE (300) radio access capabilities, to the SeNB 600. In response to the SeNB setup message from the MeNB 500, the SeNB 600 performs an admission control procedure regarding whether or not the requested bearer has been configured through the Radio Admission Control (RAC) of the RRM, and transfers an SeNB setup ACK message, including a result code, to the MeNB 500 (an SeNB setup request step) at step S2605. In this case, in the Alt.Arch.2, the SeNB 600 performs only an RAC function on the radio bearer requested by the MeNB 500.

Thereafter, if the SeNB 600 accepts the SeNB setup request received from the MeNB 500, the SeNB 600 configures the radio resources of the SeNB 600 using the information about the attributes of the radio bearer for dual connectivity that is included in the SeNB setup request message (an SeNB radio resource configuration step) at step S2606. If the RRC connection reconfiguration procedure between the SeNB 600 and the MeNB 500 and the UE 300 is successful through such a procedure, the radio resources configured in the SeNB 600 may be activated.

Thereafter, the MeNB 500 may instruct the UE 300 to add an SeNB for dual connectivity in response to the RRC connection reconfiguration message (an RRC connection reconfiguration request step for SeNB addition) at step S2607. If the MeNB 500 does not instruct the UE 300 to perform contention-based-random access, preliminary information related to such random access is not included in the RRC connection reconfiguration message.

In response to the SeNB addition instruction from the MeNB 500, the UE 300 performs a non-contention-based or a contention-based random access procedure and obtains uplink synchronization (an uplink synchronization step) at step S2608. If contention-based-random access is instructed in the “RRC connection reconfiguration request step for SeNB addition”, a random access procedure according to the 3GPP TS 36.321 standard may be performed.

After obtaining the uplink synchronization, the UE 300 may configure its radio resources based on information included in the RRC connection reconfiguration message received from the MeNB 500 in the “RRC connection reconfiguration request step for SeNB addition” (a radio resource configuration step) at step S2609. That is, the UE 300 may configure radio bearer (RB) connection with the SeNB 600.

After the UE 300 completes the radio resource configuration procedure, the UE 300 notifies the MeNB 500 that the SeNB addition has been completed. To this end, the UE 300 uses an RRC connection reconfiguration complete message (an RRC connection reconfiguration ACK step for SeNB addition) at step S2610.

In response to an SeNB addition ACK message from the UE 300, the MeNB 500 sends an SeNB setup complete message to the SeNB 600 (an SeNB setup complete step) at step S2611. In the Alt.Arch.2, the SeNB setup complete message is transferred from the MeNB 500 to the SeNB 600 because the subject that has ordered the SeNB setup is the MeNB 500. Such a procedure is different from that in the structure of the Alt.Arch.1.

Thereafter, as in the Alt.Arch.1, the MeNB 500 performs a step of updating RRC context (an RRC context update step) at step S2612, and the UE 300 performs a step of performing communication based on dual connectivity (a dual connectivity-based communication step) at step S2613.

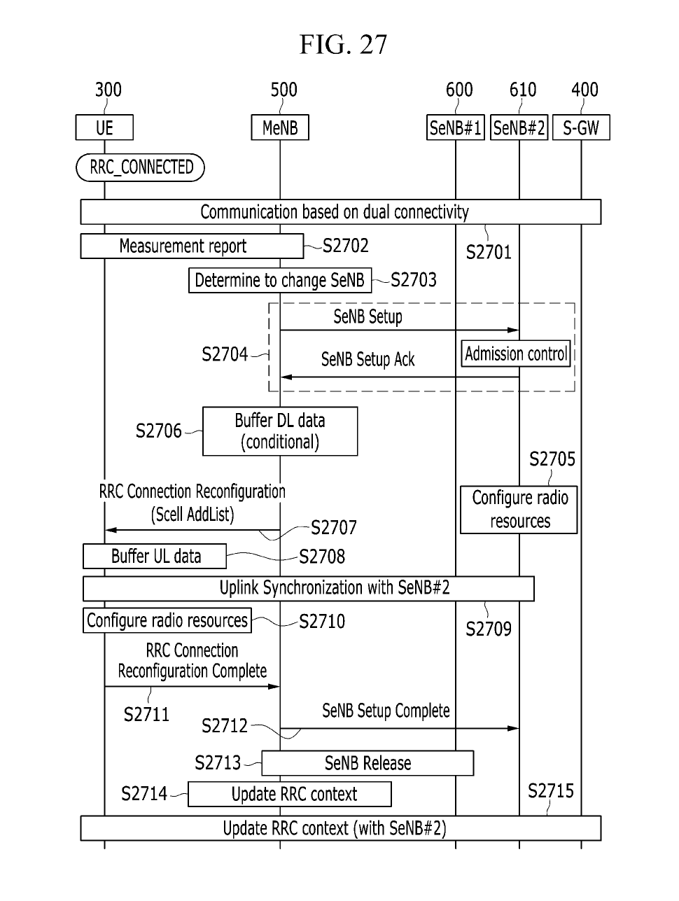

FIG. 27 is a flowchart illustrating a method of changing an SeNB in accordance with another exemplary embodiment of the present invention.

The method of changing an SeNB of the Alt.Arch.2 in accordance with another exemplary embodiment of the present invention relates to a change of the SeNB 600 for providing dual connectivity to the UE 300 under the control of the MeNB 500.

First, in FIG. 27, a “dual connectivity-based communication step S2701”, a “measurement report step S2702”, and an “SeNB change determination step S2703” are the same as those of the SeNB change method C1 of the Alt.Arch.1.

Thereafter, a “new SeNB setup request step S2704” and a “new SeNB radio resource configuration step S2705” are the same as the “SeNB setup request step” and the “SeNB radio resource configuration step” of the SeNB addition method described with reference to FIG. 26.

Thereafter, the “downlink data buffering step of the MeNB 500” S2706 is the same as the “downlink data buffering step” of the SeNB change method C1 of the Alt.Arch.1.

Thereafter, an “RRC connection reconfiguration request step S2707 for new SeNB addition” is the same as the “RRC connection reconfiguration request step for SeNB addition” of the SeNB addition method of FIG. 26.

Thereafter, an “uplink data buffering step S2708” is the same as the “uplink data buffering step” of the SeNB change method C1 of the Alt.Arch.1.

Thereafter, the “uplink synchronization step S2709” of the UE 300, a “radio resource configuration step S2710” of the UE 300, an “RRC connection reconfiguration ACK step S2711 for new SeNB addition”, and a “new SeNB setup complete step S2712” are the same as those of the SeNB addition method of FIG. 26.

Finally, an “existing SeNB release step S2713”, an “RRC context update step S2714”, and a “dual connectivity-based communication step S2715” are the same as those of the SeNB change method C1 of the Alt.Arch.1.

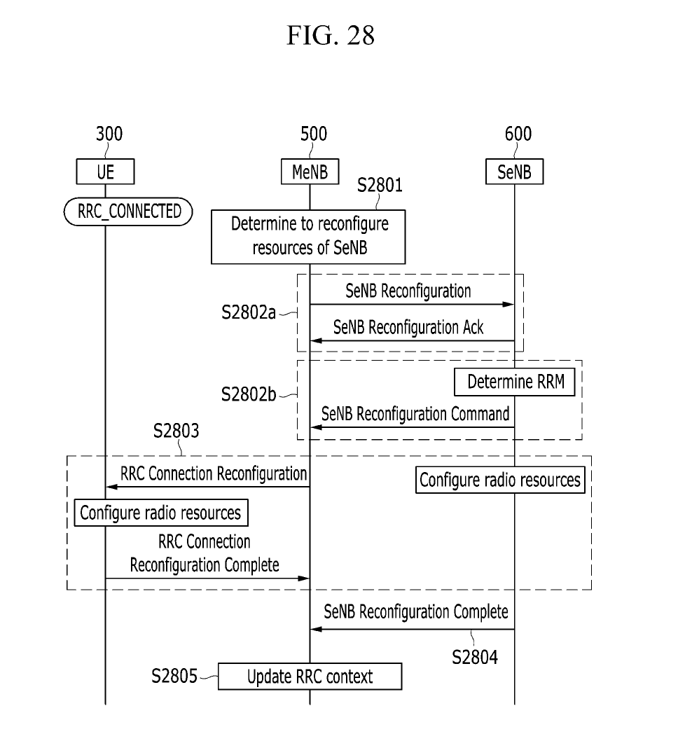

FIG. 28 is a flowchart illustrating a method of reconfiguring an SeNB in accordance with another exemplary embodiment of the present invention.

In the present invention, the SeNB reconfiguration method is for changing the configuration of radio resources, allocated to an SeNB, under the control of the MeNB 500 or in response to a request from the SeNB 600.

First, At step of S2801(a), the MeNB 500 starts an SeNB reconfiguration. At this step, the MeNB 500 determines whether or not to change information about the configuration of radio resources allocated to the SeNB 600 by taking into consideration information about the channel of the SeNB 600 that has been measured and reported by the UE 300 (an SeNB reconfiguration determination step). And the MeNB 500 sends an SeNB reconfiguration message, including a parameter for reconfiguring the radio bearers of the SeNB 600 and a radio bearer identifier, to the SeNB 600. In response to the SeNB reconfiguration message from the MeNB 500, the SeNB 600 determines whether or not to accept the corresponding request through the RBC function of the RRM and then sends an SeNB reconfiguration ACK message to the MeNB 500.

At step S2801(b), the SeNB 600 starts an SeNB reconfiguration. At this step, the SeNB 600 sends the reconfiguration command of the SeNB 600 to the MeNB 500. In this case, the SeNB 600 transfers the parameter for reconfiguring the radio resources of the SeNB 600 to the MeNB 500 through the RRM function of the SeNB 600. If such a procedure is performed, there is a need for a procedure for exchanging pieces of resource configuration information between the MeNB 500 and the SeNB 600 because the SeNB 600 starts the SeNB reconfiguration using an independent RRM. SeNB 600 may allocate radio resources for dual connectivity on the basis of the information about the capability of the UE 300 and the information about the radio resources allocated to the MeNB 500.

In the present invention, in order to exchange pieces of radio resource configuration information between the MeNB 500 and the SeNB 600, the information about the capabilities of the UE 300 included in the SeNB setup message of the SeNB addition procedure may be used. The following three methods of sharing radio resource configuration information may be taken into consideration.

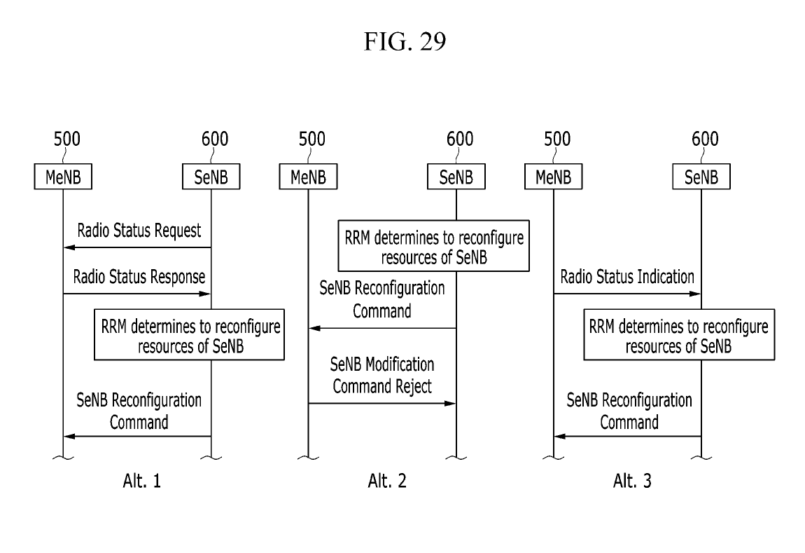

FIG. 29 is a flowchart illustrating a method of sharing radio resource allocation information in the Alt.Arch.2 in accordance with another exemplary embodiment of the present invention.
Alt.1: two-way handshake before reconfiguration prior to reconfiguration

In such a method, when the SeNB 600 determines an RRM for a reconfiguration, the SeNB 600 sends, to the MeNB 500, a radio status request message that requests information about the state of radio resources now configured in the UE 300 that is dually connected, receives a radio status response message thereto from the MeNB 500, and shares radio resource configuration information. In accordance with the method, the SeNB 600 may perform an RRM procedure based on the state of the radio resources of the UE 300 and the radio access capabilities of the UE 30, received from the MeNB 500, when reconfiguring the SeNB 600. If the SeNB 600 starts the SeNB reconfiguration procedure in accordance with the method, however, a signaling procedure for obtaining information about radio resources allocated to the UE 300 is always required between the SeNB 600 and the MeNB 500 prior to the reconfiguration procedure, which may result in delay.
Alt 2: one-way indication during modification when the capabilities of the UE 300 are exceeded

In such a method, the SeNB 600 transfers a reconfiguration command.

In response to the reconfiguration command, the MeNB 500 determines whether or not to permit a change of radio resources (i.e., a radio resource reconfiguration) allocated to the SeNB 600 based on information about radio resources now configured for the UE 300. If an SeNB reconfiguration is permitted through such a method, the MeNB 500 performs the SeNB reconfiguration through an RRC reconfiguration procedure. If the SeNB reconfiguration is not permitted through such a method, the MeNB 500 sends a message of rejection of the corresponding request to the SeNB 600. The reconfiguration rejection message transferred to the SeNB 600 may include a cause and information about radio resources now allocated to the MeNB 500 and the UE 300. In response to the reconfiguration rejection message, the SeNB 600 determines whether or not to perform an SeNB reconfiguration procedure again or to stop the reconfiguration procedure based on the received radio resource allocation information. Such a method is advantageous in that delay attributable to a signaling procedure between the MeNB 500 and the SeNB 600 can be reduced because a reconfiguration may be performed without additional signaling between the MeNB 500 and the SeNB 600 if the reconfiguration requested by the SeNB 600 does not exceed the current capabilities of the UE 300. If the reconfiguration requested by the SeNB 600 exceeds the current capabilities of the UE 300, however, a procedure for transferring, by the MeNB 500, the response message of the corresponding reconfiguration to the SeNB 600 and performing a modification again or stopping the corresponding request based on the response message is required, which may also require a corresponding signaling procedure.
Alt 3: one-way reporting at an arbitrary time

In such a method, the MeNB 500 transfers information about radio resources, allocated to the UE 300 that is dually connected, to the SeNB 600 periodically or when there is a change of radio resources that have been configured in the UE 300 and that are to be configured by the MeNB 500. In accordance with the method, the SeNB 600 may perform an RRM decision function for an SeNB reconfiguration procedure using information about radio resources allocated to the UE 300 that has been received from the MeNB 500. This method is advantageous in that an additional signaling procedure between the SeNB 600 and the MeNB 500 is not required when the SeNB 600 performs a reconfiguration. If information about the radio resources of the UE 300 is changed dynamically and frequently, however, this method is disadvantageous in that a load attributable to signaling for sharing information about radio resources used between the MeNB 500 and the SeNB 600 is increased.

Referring back to FIG. 28, if the radio resources allocated to the SeNB 600 are determined to be changed, the MeNB 500 requests an RRC connection reconfiguration from the UE 300 at step S2802. In this case, configuration information for PHY, MAC and RLC connection between the SeNB 600 and UE 300 may be included in the RRC connection reconfiguration message transmitted from MeNB 500 to UE 300. Thereafter, the UE 300 reconfigures the radio resources and sends an RRC connection reconfiguration complete message to the MeNB 500 at step S2803. In response to the RRC connection reconfiguration complete message, the MeNB 500 sends an SeNB reconfiguration complete message to the SeNB 600 and updates RRC context at step S2804.

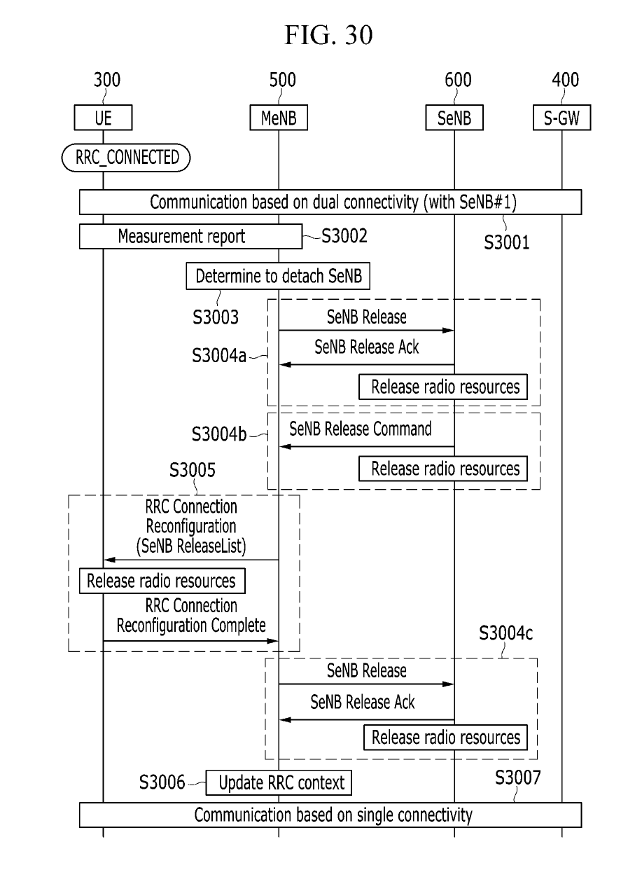

FIG. 30 is a flowchart illustrating a method of releasing an SeNB in the Alt.Arch.2 in accordance with another exemplary embodiment of the present invention.

In the SeNB release procedure, the connection of the SeNB 600 with the UE is released under the control of the MeNB 500 or in response to a request from the SeNB 600.

First, a “dual connectivity-based communication step S3001” and a “measurement report step S3002” are the same as those of the SeNB release method of the Alt.Arch.1.

Thereafter, the MeNB 500 determines the SeNB release and releases the radio resources of a radio bearer configured in the SeNB 600 (an SeNB release request step). In the present invention, the following three types may be taken into consideration.

At step S3003(a), the MeNB 500 determines the SeNB 600 release and requests the SeNB 600 to release its radio resources. At this step, the MeNB 500 requests the SeNB 600 to release its radio resources based on a result of measurement received from the UE 300. In response to the request, the SeNB 600 may release its radio resources for the corresponding UE 300 or bearer and then transfers a release ACK message to the MeNB 500.

At step S3003(b), the SeNB 600 orders the release of radio resources. At this step, the SeNB 600 instructs the MeNB 500 to release the radio resources of the SeNB 600 (i.e., an SeNB release command) based on a result of the determination of the RRM. In response to the instruction, the MeNB 500 may release the radio resources of the UE 300. Thereafter, MeNB 500 transfers RRC Connection Reconfiguration message to release the SeNB 600 to the UE 300. In this case, configuration information for PHY, MAC and RLC connection between the SeNB 600 and UE 300 may be included in the RRC Connection Reconfiguration message transmitted from MeNB 500 to UE 300. The UE 300 receives the RRC Connection Reconfiguration message from the MeNB 500 and releases the radio resources (radio bearer configured to the SeNB 600) and sends an RRC Connection Reconfiguration complete message to the MeNB 500 at step S3004.

Unlike in the procedure of S3003(a) and S3003(b), at S3003(c), the MeNB 500 deliberately releases the radio resource of the SeNB 600. After the “RRC context update step”, the MeNB 500 releases the radio bearer of the UE 300 to the SeNB 600 and transfers an SeNB release message for informing the release of the radio resources to the SeNB 600.

After receiving the SeNB release message, the SeNB600 recognizes the release of the radio resource through the SeNB release message and performs a procedure for releasing the requested radio resources and transfers an SeNB release ACK message to the MeNB 500.

Thereafter, the MeNB 500 updates RRC context (an RRC context update step) at step S3006. The UE 300 may perform single connectivity-based communication with the MeNB 500 (a single connectivity-based communication step) at step S3006.

In the Alt.Arch.2, a method of reporting the buffer state of the SeNB 600 may be different from a method of reporting the SeNB buffer state of the Alt.Arch.1.

Pieces of information exchanged between the MeNB 500, the SeNB 600, and the UE 300 and a method of exchanging the pieces of information in order to provide dual connectivity through the Alt.Arch.2 are described below.

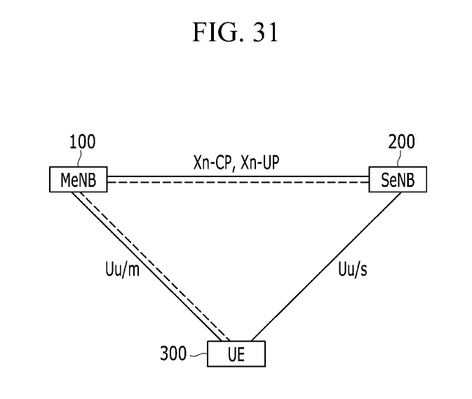

FIG. 31 is a diagram illustrating the connection state of the MeNB 500, the SeNB 600, and the UE 300 in the Alt.Arch.2 in accordance with another exemplary embodiment of the present invention.

Referring to FIG. 31, reference points between the MeNB 500 and the SeNB 600 are Xn-CP and Xn-UP, a reference point between the MeNB 500 and the UE 300 is Uu/m, and a reference point between the SeNB 600 and the UE 300 is Uu/s.

In the control plane of the Alt.Arch.2 for providing dual connectivity, Xn-CP, that is, the control plane interface between the MeNB 500 and the SeNB 600, may provide the following functions.
*Function for configuring SeNB radio resources for providing dual connectivity
Setup, change, and release of SeNB resources
Reconfiguration of SeNB resources
Report on an SeNB buffer state
Flow control between an MeNB and an SeNB: this function may be performed when flow control using a control plane protocol is performed.
*Xn-UP management
Function for managing traffic bearers between an MeNB and an SeNB (i.e., the setup, change, and release of traffic bearers)
*RLF report from an SeNB to an MeNB

Xn-CP is a signaling protocol of an application level that operates based on an SCTP/IP-based transport network like X2-CP, and has the same structure as that of FIG. 18.

Uu/m, that is, a control plane interface between the MeNB 500 and the UE 300 for providing dual connectivity, may provide the following functions.
*RRC function for dual connectivity
RRC connection reconfiguration

Setup, change, and release of an SeNB

An SeNB reconfiguration
Measurement configuration and reporting

Management of an SeNB

Table 7 illustrates messages exchanged through Xn-CP and Uu if dual connectivity is provided through the Alt.Arch.2.

TABLE 7

| Protocol message | Descriptions | RP | IEs | Remark |
|---|---|---|---|---|
| SeNB Setup | SeNB configuration | Xn-CP | Setup type | |
| | request message | | Bearer | |
| | | | attribute | |
| | | | C-RNTI | |
| | | | Xn-U info. | |
| | | | Security key | |
| SeNB Setup ACK | SeNB configuration ACK | Xn-CP | Result code | |
| | message | | | |
| SeNB Setup | SeNB configuration | Xn-CP | | |
| Complete | complete message | | | |
| RRC Connection | | Uu/m | SeNB | |
| Reconfiguration | | | addition list | |
| | | | Cause | |
| RRC Connection | | Uu/m | | |
| Reconfiguration | | | | |
| Complete | | | | |
| Packet Transfer | Transfer request message | Xn-CP | | |
| | of buffered packet | | | |
| Packet Transfer | Packet transfer ACK | Xn-CP | | |
| ACK | message | | | |
| SeNB Release | SeNB release request | Xn-CP | | |
| | message | | | |
| SeNB Release | SeNB release ACK | Xn-CP | | |
| ACK | message | | | |
| SeNB | SeNB reconfiguration | Xn-CP | RB id. | Add list |
| reconfiguration | request message | | SeNB | |
| | | | modification | |
| | | | list | |
| SeNB | SeNB reconfiguration | Xn-CP | Result code | |
| reconfiguration | ACK message | | | |
| ACK | | | | |
| Resource Status | Downlink buffer | Xn-CP | DL buffer | |
| Update | information report | | status | |
| | message of SeNB | | | |

In Table 7, the information entities included in the messages exchanged through Xn-CP comply with the definition of the information entities of Table 5.

In the user plane of the Alt.Arch.2 for providing dual connectivity, Xn-UP, that is, a user plane interface between the MeNB 500 and the SeNB 600, may provide the following functions.
*Transfer of traffic between an MeNB and an SeNB
Flow control between an MeNB and an SeNB: This function may be performed when flow control using a user plane protocol is performed.

Furthermore, Xn-UP operates based on a GTP-U/UDP-based transport network like X2-UP, and has the same structure as that of FIG. 19.

In the user plane of the Alt.Arch.2 for providing dual connectivity, Uu-UP/m, that is, a user plane interface between the MeNB 500 and the UE 300, may provide the following functions.
*Management of PDCP PDUs
Ordering and in-sequence delivery of PDCP PDUs

In accordance with an exemplary embodiment of the present invention, UE may be simultaneously connected (or dually connected) to at least one base station and provided with service. In this case, the base station dually connected to the UE may be divided into a master base station and a secondary base station. The secondary base station may be connected to the bearer with UE, the secondary base station may be changed, and the connection of the secondary base station with the UE may be changed under the control of the master base station. Particularly, although the RRC and PDCP functions are not included in the secondary base station, the UE may be provided with service through the secondary base station through the RRC and PDCP functions of the master base station.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for dually connecting, by a base station, User Equipment (UE) with other base station, the method comprising:
determining a first base station of the at least one other base station;
setting up the first base station;
reconfiguring Radio Bearer (RB) connection of the UE with the first base station; and
performing communication based on dual connectivity with the UE and the first base station.

2. The method of claim 1, wherein determining the first base station comprises setting up the first base station as a secondary eNB (SeNB) for the UE.

3. The method of claim 2, wherein determining the first base station comprises determining the first base station by taking a load of the base station into consideration.

4. The method of claim 2, wherein setting up the first base station comprises:
transferring a Secondary eNB (SeNB) setup message to the first base station; and
receiving a response to the SeNB setup message from the first base station.

5. The method of claim 4, wherein the SeNB setup message comprises at least one of information about a Cell-Radio Network Temporary Identifier (C-RNTI) of the UE, information about attributes of a bearer to be configured, and information about UE radio access capabilities.

6. The method of claim 4, wherein the response to the SeNB setup message comprises a result code generated after an admission control procedure regarding whether a bearer has been configured is performed.

7. The method of claim 1, wherein reconfiguring the RRC connection comprises:
instructing the UE to access the first base station; and
receiving a completion message for the access instruction from the UE.

8. The method of claim 1, further comprising sending an SeNB setup complete message to the first base station after reconfiguring the RRC connection.

9. A method for dually connecting, by a User Equipment (UE) connected to a base station, a first base station that is different from the base station, the method comprising:
reconfiguring Radio Bearer (RB) connection with the first base station determined as a secondary eNB (SeNB) by the base station; and
performing communication based on dual connectivity with the base station and the first base station.

10. The method of claim 9, wherein reconfiguring the RB connection comprising:
receiving reconfiguration command instructing the RB connection with the first base station from the base station; and
performing uplink synchronization with the first base station.

11. The method of claim 10, wherein reconfiguring the RB connection further comprising setting up the RB on the basis of the reconfiguration command after the performing the uplink synchronization.

12. The method of claim 10, wherein reconfiguration command comprising information related random access for the first base station,
wherein the performing the uplink synchronization comprises performing non-contention based random access for the first base station.

13. The method of claim 10, wherein performing the uplink synchronization comprising performing contention based random access for the first base station.

14. The method of claim 10, wherein reconfiguring the RB further comprising transmitting an RRC Connection Reconfiguration complete message to the first base station.

15. The method of claim 9, further comprising receiving instruction of measurement for finding the first base station and periodically performing the measurement for finding the first base station before reconfiguring the RB.

16. The method of claim 15, further comprising reporting a result of the measurement when the UE finding the first base station matched a configuration condition, wherein the instruction of measurement comprising the configuration condition of the first base station.

17. A method of changing, by User Equipment (UE) dually connected with master eNB (MeNB) and secondary eNB (SeNB), the SeNB in a wireless communication system, the method comprising:
releasing Radio Bearer (RB) connection with first base station connected as former SeNB and reconfiguring the RB connection with second base station determined as latter SeNB; and
performing communication based on dual connectivity with the MeNB and the second base station.

18. The method of claim 17, wherein reconfiguring the RB connection comprising receiving an Radio Resource Control (RRC) connection reconfiguration message from the MeNB.

19. The method of claim 18, wherein the RRC Connection reconfiguration message comprising information related to the second base station and list of secondary cell included in coverage of the second base station.

20. The method of claim 18, wherein reconfiguring the RB connection comprising:
buffering uplink data set for transmitting to the first base station; and
performing uplink synchronization with the second base station,
wherein the performing communication comprising transferring the buffered data to the second base station.
